(19) United States
(12) Patent Application Publication
(10) Pub. No.: US 2024/0376737 A1
(43) Pub. Date: Nov. 14, 2024

(54) AUTOMATIC POOL CLEANER

(71) Applicant: Shenzhen Aiper Intelligent Co., Ltd., Shenzhen (CN)

(72) Inventors: Yang WANG, Shenzhen (CN); Xueliang YU, Shenzhen (CN); Liangwen YE, Shenzhen (CN); Jiyong ZHOU, Shenzhen (CN); Zhiguang YANG, Shenzhen (CN)

(21) Appl. No.: 18/772,294

(22) Filed: Jul. 15, 2024

Related U.S. Application Data
(63) Continuation of application No. PCT/CN2024/070985, filed on Jan. 5, 2024.

(30) Foreign Application Priority Data
Feb. 14, 2023 (CN) 202310112439.2
Apr. 20, 2023 (CN) 202310461751.2
Jul. 11, 2023 (CN) 202321815957.2
Aug. 22, 2023 (CN) 202311063523.6

(51) Int. Cl. E04H 4/16

(52) U.S. Cl. CPC E04H 4/1654

(57) ABSTRACT

An automatic pool cleaner includes a housing, a filtering module, and an out-of-water detection module. The housing defines a water inlet and a water outlet; The filtering module is configured to filter fluid from the water inlet to provide filtered fluid. The out-of-water detection module comprises a floating unit and a sensing unit, which can make the floating unit move between the first and the second positions according to whether the pool cleaner is above the waterline. The sensing unit identifies the position of the floating unit and outputs a first signal or a second signal to the pool cleaner, thereby determining whether the pool cleaner is above the water surface.

### CROSS-REFERENCE TO RELATED APPLICATIONS

The present application is a continuation of International Application No. PCT/CN2024/070985, with an international filing date of Jan. 5, 2024, which claims priority to Chinese Patent Applications No. 202310112439.2, No. 202311063523.6, No. 202321815957.2, No. 202310461751.2, the contents of which are incorporated herein by reference.

### TECHNICAL FIELD

The present invention relates to the robotic technical field, in particular to a automatic pool cleaner.

### BACKGROUND

The automatic pool cleaner is a cleaner produced for the demand of swimming pool cleaning. In the prior art, when the automatic pool cleaner cleans the water line near the water surface of the pool, whether the automatic pool cleaner is out of the water surface of the pool cannot be accurately judged, which makes the control end unable to control the automatic pool cleaner to perform corresponding cleaning operations at the water line of the pool, resulting in poor cleaning effect.

### SUMMARY

Accordingly, there is a desire for an improved automatic pool cleaner.

In one aspect, an automatic pool cleaner includes a housing, a filtering module, and an out-of-water detection module. The housing defines a water inlet and a water outlet; The filtering module is configured to filter fluid from the water inlet to provide filtered fluid.

The out-of-water detection module comprises a floating unit and a sensing unit. The floating unit is moveable between a first and a second position. When the floating unit is in the first position, the sensing unit outputs the first signal; When the floating unit is in the second position, the sensing unit outputs a second signal.

Compared with the prior art, by arranging the out-of-water detection module at one end of the housing, the automatic pool cleaner could be detected by the out-of-water detection module when it is just above the pool waterline, so the judgment of whether the automatic pool cleaner is out of water is more sensitive. The out-of-water detection module includes a floating unit and a sensing unit, which can make the floating unit move between the first and the second positions according to whether the pool cleaner is out of the waterline, and then identify the position of the floating unit through the sensing unit to send the first signal or the second signal to the automatic pool cleaner, so as to judge whether the automatic pool cleaner is above the water surface. Compared with the prior art, the automatic pool cleaner disclosed in the application can realize the purpose of accurately judging whether the automatic pool cleaner is out of the water surface of the pool.

### BRIEF DESCRIPTION OF THE DRAWINGS

The present invention is described in detail in combination with embodiments and drawings, in which:

FIG. 1 shows a structural diagram of an automatic pool cleaner provided according to embodiments of the present invention;

FIG. 2 shows a structure diagram from another angle of an automatic pool cleaner provided according to FIG. 1;

FIG. 3 shows a structure diagram removing the top cover of an automatic pool cleaner provided according to FIG. 1;

FIG. 4 shows a bottom view of an automatic pool cleaner provided according to FIG. 1;

FIG. 5 shows a front view of removing the side cover of an automatic pool cleaner provided according to FIG. 1;

FIG. 6 shows a profile of an automatic pool cleaner provided according to FIG. 1;

FIG. 7 shows a structural diagram of the containing structure and the truncated part of the housing of an automatic pool cleaner provided according to FIG. 1;

FIG. 8 shows an enlarged view of area A in an automatic pool cleaner provided according to FIG. 6;

FIG. 9 shows an enlarged view of area B in an automatic pool cleaner provided according to FIG. 6;

FIG. 10 is a schematic diagram of the internal structure of the automatic pool cleaner of the present invention in an embodiment;

FIG. 11 is a schematic diagram of the internal structure of the automatic pool cleaner of the present invention in another embodiment;

FIG. 12 is a schematic diagram of the signal transmission principle of the swimming pool cleaning system of the present invention in an embodiment;

FIG. 13 is a structural diagram of the automatic pool cleaner in Embodiment 1;

FIG. 14 is a structural diagram of the cleaner in Embodiment 1 moving vertically upward underwater while cleaning the pool wall;

FIG. 15 is a structural diagram of the cleaner in Embodiment 1 moving vertically upward above a water line while cleaning the pool wall;

FIG. 16 is a structural diagram of the cleaner in Embodiment 2 moving vertically upward and underwater while cleaning the pool wall;

FIG. 17 is a structural diagram of the cleaner in Embodiment 2 moving vertically upward above a water line while cleaning the pool wall;

FIG. 18 is a structural diagram of the cleaner in Embodiment 2 moving horizontally underwater while cleaning the pool bottom;

FIG. 19 is the structural diagram of the cleaner in Embodiment 2 moving horizontally above a water line when cleaning the pool bottom.

FIG. 20 is a simplified schematic diagram of the charging system structure of Embodiment I in the present invention.

FIG. 21 is a section view I of the automatic pool cleaner of an embodiment in the present invention;

FIG. 22 is a section view II of the automatic pool cleaner of an embodiment in the present invention;

FIG. 23 is a partial structural explosion view of an automatic pool cleaner of an embodiment in the present invention;

FIG. 24 is an explosion view of the second filter device and quick-release mount of the automatic pool cleaner of an embodiment in the present invention.

### DETAILED DESCRIPTION OF THE EMBODIMENTS

To make the objectives, technical solutions and advantages of the embodiments of the present invention clearer, a detailed description of the technical solutions in the present invention will be further given below, in combination with the drawings corresponding to the embodiments. Examples of embodiments are shown in the drawings, in which like or similar reference numbers refer to the same or similar parts throughout or parts having the same or similar functions. The embodiments described below with reference to the drawings are illustrative and only intended to be illustrative of the present invention and are not to be construed as limiting the present invention.

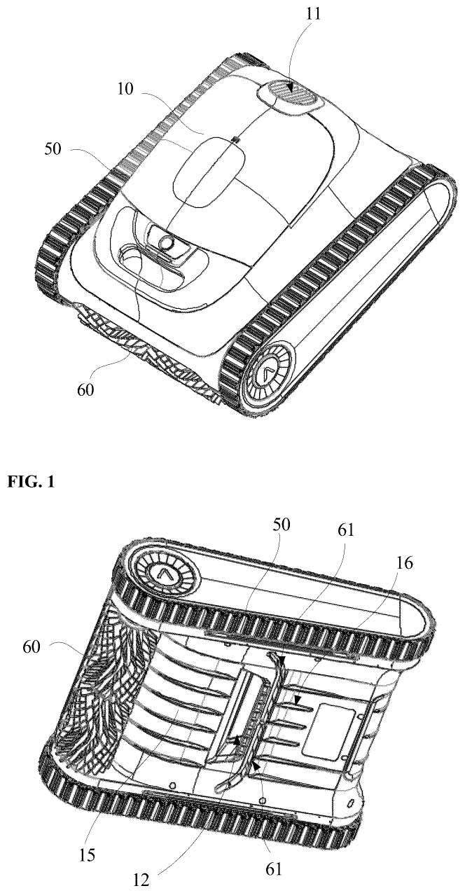

Please refer to FIG. 1 to FIG. 6, The present invention claims an automatic pool cleaner, including a housing 10, a filter module 20, and a water pump module 30. The housing 10 has a water inlet 12 and a water outlet 11, the water inlet 12, a filtering module 20 and the water outlet 11 are successively interconnected, and the water pump module 30 is communicated with the filtering module 20. It also includes a driving module 50, which drives the movement of the automatic pool cleaner; The cleaning module 60 is installed on the housing 10, and the drive module 50 is connected with the drive of the cleaning module 60. It should be noted that the drive module 50 can simultaneously drive the movement of the automatic pool cleaner and the cleaning module 60, which makes the overall structure more compact and smaller, but also conducive to reducing costs.

Specifically, the drive module 50 includes a power motor, a moving part and a transmission part, wherein the moving part is connected with the housing 10, the power motor drives the moving part to move, the power motor is connected with the transmission part, and the power motor drives the cleaning module 60 to move through the transmission part. The cleaning module 60 may be a cleaning roller brush or a reciprocating brush and other cleaning structures. In some embodiments, the cleaning module 60 is a cleaning roller brush.

Please refer to FIG. 5 and FIG. 6, in some embodiments, the automatic pool cleaner also includes a drain module 70, and the housing 10 is provided with a first chamber 13 within it. The first chamber 13 is externally connected/closed by a drain module 70. It should be noted that when the automatic pool cleaner is above the water surface for corresponding cleaning, part of the automatic pool cleaner will be above the water surface, resulting in reduced buoyancy of the automatic pool cleaner. Under the condition that the weight remains unchanged, the driving parts of the automatic pool cleaner will need more power to keep the automatic pool cleaner above the water surface. Or, when the automatic pool cleaner needs to be lifted by the user, the water in the first chamber 13 needs to be quickly drained. Therefore, the first chamber 13 is provided at the front end of the direction of travel of the automatic pool cleaner. When the automatic pool cleaner is under the water surface, water enters the first chamber 13. In addition, a drain module 70 is provided, and the first chamber 13 is connected/scaled to the outside through the water drain module 70, so that when the automatic pool cleaner is above the water surface, the drain module 70 can discharge the water in the first chamber 13, thereby reducing the overall weight of the automatic pool cleaner and the power consumption of the automatic pool cleaner when it is above the water surface, achieving the purpose of extending the battery life of the automatic pool cleaner, and reducing the weight of the cleaner, which can be easily lifted.

Please refer to FIG. 5 and FIG. 6, in some specific embodiments, the drain module 70 is a drain opening on the side wall of the first chamber 13. Specifically, the drain module 70 is a drain opening on the side wall of the first chamber 13. By restricting the drain opening to be in front of the water inlet 12, the water in the first chamber 13 can be discharged through the drain opening when the end of the drain module 70 is above the water surface. Such a setup can make the structure of the drain module 70 simple. At the same time, when the automatic pool cleaner is underwater, the drain opening can assist the water inlet 12, so that the automatic pool cleaner can quickly sink. In other embodiments, the drain module 70 can also be externally connected/closed by using an electronically controlled method.

In some specific embodiments, an out-of-water detection module is in the first chamber 13. It should be noted that in order to protect the out-of-water detection module from damage and interference from splashing in the pool, the out-of-water detection module is arranged in the first chamber 13, thereby extending the service life of the out-of-water detection module and improving the stability performance during use.

Please refer to FIG. 6, in some embodiments, the water inlet 12, the filtering module 20, and the water outlet 11 are successively interconnected and form a filter flow channel; The interior of the housing 10 is provided with the separated first chamber 13 and the second chamber 14, and the filter flow channel is only arranged in one of the first chamber 13 and the second chamber 14. By setting the first chamber 13 and the second chamber 14 separated from each other in the interior of the housing 10, and connecting the filter flow channel with only one of the first chamber 13 and the second chamber 14, the water entering the water inlet 12 only passes through the first chamber 13 or the second chamber 14, so that the space for the water pump module 30 to work is greatly reduced. Large power is not required to achieve the purpose of pumping water, reducing the energy consumption of the automatic pool cleaner, and improving the endurance performance, that is, under the condition of a certain pump power, the efficiency of filtering and cleaning is improved. Compared with the prior art, the automatic pool cleaner disclosed in the application can realize the purpose of reducing the energy loss in the working process of the automatic pool cleaner.

Among them, one of the first chamber 13 and the second chamber 14 is provided with a filter flow channel. It should be noted that it is not necessary to completely seal the first chamber 13 and the second chamber 14. The purpose of reducing energy loss required by the application can be achieved by making most of the water flow through the chamber where the filter flow channel is located. It should be noted that the water pump module 30 needs to work on the water in the housing 10 and pump water out to the external environment through the water outlet 11 during operation. If the chamber in the housing 10 is too large, the drainage area through which the water enters the housing 10 from the bottom will be large, and it is easy to form turbulence, vortex, and other phenomena. It causes the water flow to consume a lot of work in the housing 10, wastes the work of the pump, and increases the energy consumption of the pump, which not only reduces the power of the pump but also reduces the endurance performance of the automatic pool cleaner. However, in the application, by setting two chambers separated from each other, most of the water flows only through one of them and installing the power sealed bin, sensor, etc., in another chamber, water flows through a smaller space, and the water flow is constrained to reduce turbulence, vortex, etc., which is conducive to the circulation of water flow, improve the efficiency, and improve the endurance of the machine.

In addition, the specific power of the water pump module 30 can be determined according to the specific volume of the first chamber 13 or the second chamber 14 communicated with the filter flow channel, so that the specific power of the pump module 30 matches the volume of the chamber. Thus, the pump module 30 can work under the appropriate power, without causing insufficient suction or wasting excess energy.

Specifically, the filter flow channel is communicated with the first chamber 13 or the second chamber 14, and another chamber can place other components on the automatic pool cleaner so that the overall structure of the automatic pool cleaner is more compact and the volume of the automatic pool cleaner is reduced. At the same time, it is not restricted whether another chamber needs to be communicated with the external environment so that the external water enters the chamber.

Please refer to FIG. 5 to FIG. 7, in some specific embodiments, the first chamber 13 and the second chamber 14 are separated by the filtering module 20; Or, the first chamber 13 and the second chamber 14 are separated by a partition plate fixed on the inner wall of the housing 10. It should be noted that in order to further optimize the internal structure of the automatic pool cleaner, make the arrangement between modules more compact, and achieve the purpose of reducing the volume of the automatic pool cleaner, the first chamber 13 and the second chamber 14 are separated by the filtering module 20, and no other structure is required to separate the first chamber 13 and the second chamber 14.

Please refer to FIG. 5 to FIG. 7, in some specific embodiments, a division board on the inner wall of the housing 10 is the wall of the automatic pool cleaner's existing module. In addition, the first chamber 13 and the second chamber 14 can also be separated by the division board fixed on the inner wall of the housing 10. Since the filtering module 20 often needs to be taken out to clean the garbage, the other parts of the automatic pool cleaner are arranged in another chamber to make the automatic pool cleaner more visually beautiful. In other embodiments, the first chamber 13 and the second chamber 14 can also be separated using the existing modules such as the drive module 50 and the control module 80.

Please refer to FIG. 5 to FIG. 7, in some more specific embodiments, the filtering module 20 includes a rubbish filter 22 and a containing structure 21 housing the rubbish filter box 22, with the first chamber 13 and the second chamber 14 separated by a containing structure 21. Specifically, the filtering module 20 includes the containing structure 21 and the rubbish filter 22. On the one hand, the filtering module 20 is used to separate the first chamber 13 and the second chamber 14, on the other hand, it is used to place the rubbish filter 22, further making the structure more compact.

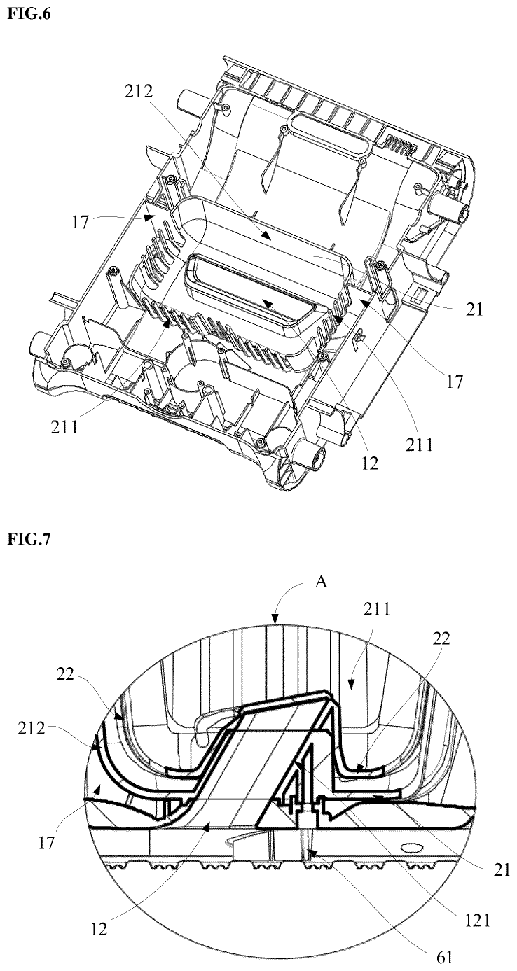

Please refer to FIG. 6 and FIG. 7, in some more specific embodiments, one side of the containing structure 21 is provided with a first partition 212. The first partition 212 separates the first chamber 13 from the second chamber 14. Specifically, the first partition 212 is arranged on one side of the containing structure 21, and the first partition 212 separates the first chamber 13 and the second chamber 14, making the automatic pool cleaner simple in structure and lighter in weight.

Please refer to FIG. 7, in some more specific embodiments, where the first partition 212 is set on one side of the containing structure 21, and a second partition plate 17 is set on the inner wall of the housing 10. The first partition plate 212 is fitted to the second partition plate 17, and the first partition plate 212 and the second partition plate 17 jointly separate the first chamber 13 from the second chamber 14. It should be noted that in order to make the interior of the containing structure 21 and the housing 10 closely fit, the second partition 17 is set on the inner wall of the housing 10, while the first partition 212 and the second partition board 17 can be directly fitted to each other.

Please refer to FIG. 7, in some more specific embodiments, the second partition 17 is abutted against and attached to the side plate of the containing structure 21. The slide plate of the containing structure 21 is on a different side of the first partition 212. Specifically, when the containing structure 21 is placed in the housing 10, the second partition 17 is abutted against and attached to the side plate of the containing structure 21, thus making the structure simple and easy to disassemble, and better the separation effect. In some embodiments, the second partition board 17 is provided with two, each of which is abutted against and attached to two side plates adjacent to and opposite the first partition 212.

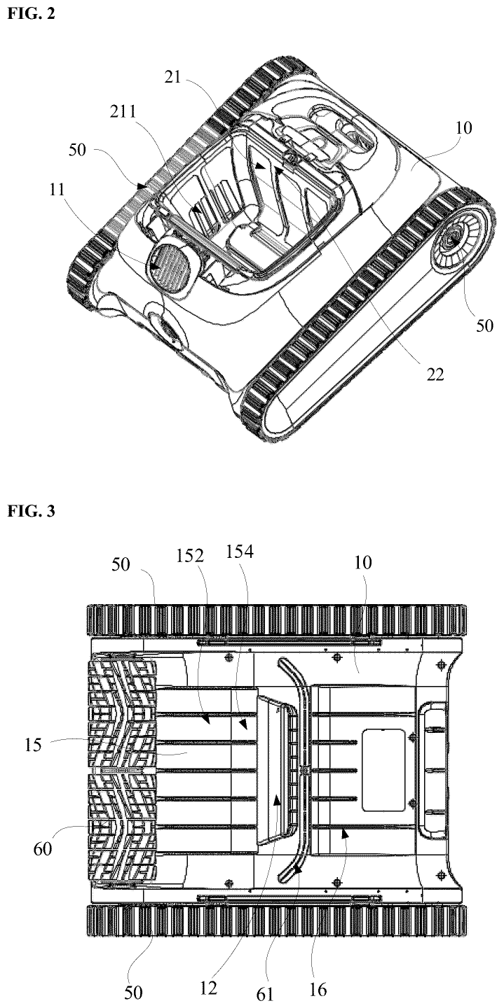

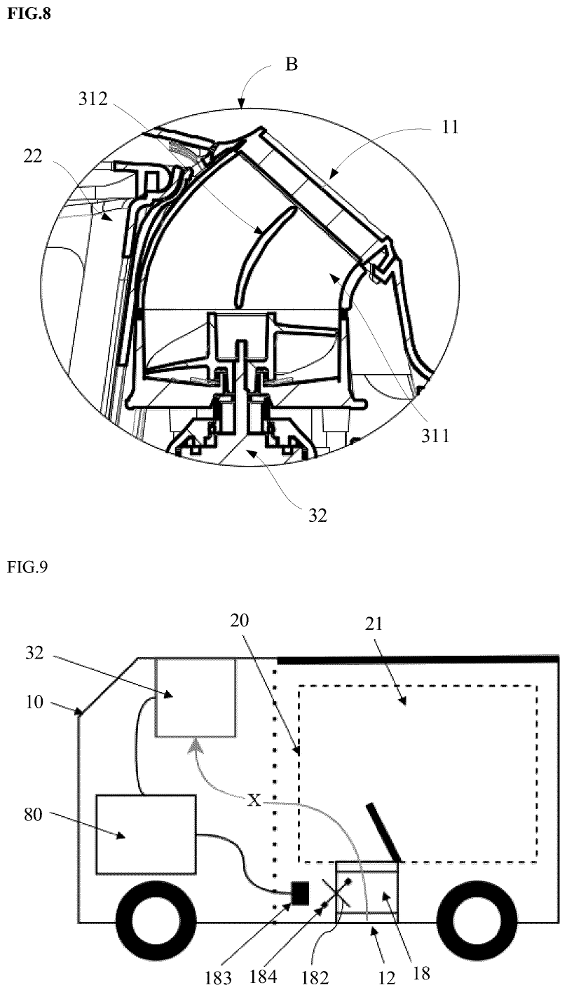

Please refer to FIG. 2, FIG. 5 and FIG. 6, in some more specific embodiments, the containing structure 21 is in the shape of a box, wherein one side of the containing structure 21 is provided with the first partition 212, and the remaining sides are provided with a sink port 211. Specifically, the containing structure 21 is a box type, wherein one side is provided with the first partition 212, and the remaining sides are provided with the sink port 211. Through the sink port 211 set on the different sides, the water filtered by the rubbish filter 22 can be quickly poured into the water pump module 30, more conducive to the discharge of water, so that the filtration speed is faster. Please refer to FIG. 6 and FIG. 9, in some embodiments, the water pump module 30 includes a guide component 31 and a power pump 32, and the water outlet 11, the guiding component 31, and the power pump 32 are successively interconnected.

It should be noted that the power pump 32 is used to provide power to discharge water in the housing 10 from the water outlet 11, and the guide component 31 is used to change the injection direction of the water pump module 30 to spray from the water outlet 11, so as to achieve the purpose of controlling the attitude of the automatic pool cleaner. Please refer to FIG. 6 and FIG. 9, in some specific embodiments, the guide component 31 includes a guide chamber 311 and a guide blade 312 set in the guide chamber 311, wherein one end of the guide chamber 311 is connected with the water outlet 11, and the other end is connected with the power pump 32.

Specifically, the guide blade 312 is arranged in the guide chamber 311 and is used to change the injection direction of water from the water outlet 11 together with the guide chamber 311. The guide blade 312 is simple in structure and easy to assemble without adding too much weight.

Please refer to FIG. 6 and FIG. 9, in some embodiments, the angle of the discharge direction of the water outlet 11 relative to the inclination of the first plane ranges from 30° to −50°. It should be noted that by tilting the direction of the water outlet 11 relative to the first plane, the angle ranges from 30° to −50°, the automatic pool cleaner has a vertical downward force and a horizontal forward force. This makes the automatic pool cleaner fit to the bottom plane, and can also help the automatic pool cleaner move forward in the horizontal direction, which is conducive to energy conservation. In some embodiments, the discharge direction of the water outlet 11 is tilted at an angle of 135° relative to the first plane. Thus, the upward and the downward component force are more equal.

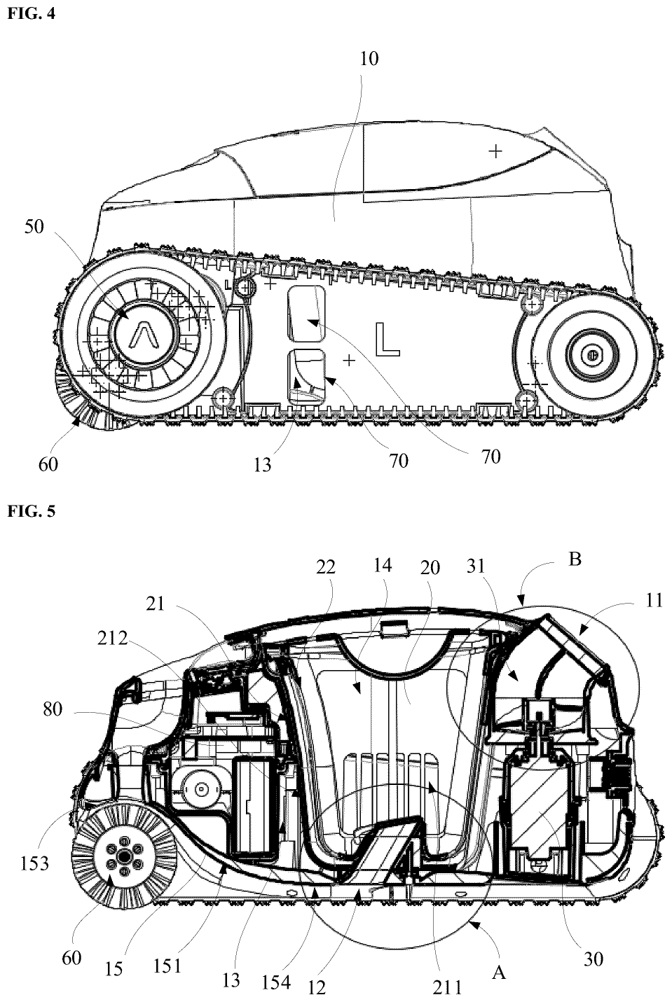

Please refer to FIG. 4 to FIG. 6, in some embodiments, the automatic pool cleaner also includes at least two wheels (the drive module 50). The wheels (the drive module 50) define a plane, which is the first plane; The bottom of the housing 10 is formed from the water inlet 12 to the end of the first plane, and the flow channel 15 is provided with an arc drainage surface 151 on the flow channel 15.

By setting the flow channel 15 with a curved structure on the bottom surface, water flows backward along the flow channel 15 during the movement of the automatic pool cleaner. As a result, most of the water flow in the direction of travel can flow backward along the flow channel 15, so that the front end of the first plane will not reduce energy consumption because of too much resistance. Compared with the prior art, the automatic pool cleaner disclosed in the application can realize the purpose of reducing the flow resistance during the movement of the automatic pool cleaner.

Among them, the wheels (drive module 50) in the plane defined by the wheels (the drive module 50) refer to the parts that drive the movement of the automatic pool cleaner, such as the crawler belt, roller or universal wheel and other parts that can move. In addition, it should be noted that when multiple wheels (the drive module 50) are in a straight line (that is, a plane cannot be defined by multiple wheels (the drive module 50)), the plane defined by the wheels (the drive module 50) refers to the plane formed by multiple wheels (the drive module 50) in a straight line and the lowest position of the bottom of the housing 10 (that is, the bottom of the housing 10 and the surface of the pool when the automatic pool cleaner is working).

It should be noted that when the automatic pool cleaner travels, the front end of its direction of travel will collide with the water flow, thus causing the water flow to form a resistance opposite to the direction of travel. On the one hand, the contact area between the front end of the direction of travel and the water flow can be reduced through the flow channel 15. On the other hand, because the flow channel 15 has a curved structure, the contact area between the housing 10 and the water flow can be reduced. Therefore, when the water flow acts on the front end of the housing 10, the flow resistance has not only the component force parallel to the first plane but also the component force perpendicular to the first plane to achieve the effect of reducing the resistance.

Please refer to FIG. 6, in some specific embodiments, the drainage surface 151 extends forward along the direction of travel of the automatic pool cleaner to form a waterside end 153, and drainage surface 151 extends backward along the direction of travel of the automatic pool cleaner to form a catchment end 154. Both ends of the drainage surface 151 are connected with the waterside end 153 and the catchment end 154 in an arc transition. Specifically, by setting the waterside end 153 and the catchment end 154, other structures on the automatic pool cleaner can be more effectively matched, playing a role in protection and drainage. At the same time, it can make the automatic pool cleaner has a more beautiful appearance. Please refer to FIG. 2 and FIG. 6, in some specific embodiments, the waterside end 153 is an indented cambered structure of the housing 10, and the wheel is arranged at the waterside end 153.

In some specific embodiments, the automatic pool cleaner also includes a cleaning module 60. The waterside end 153 is a cambered structure towards the interior of the housing 10, and the cleaning module 60 is located below the waterside end 153. On the one hand, the above settings allow the waterside end 153 of the cleaning module 60 to match the shape of the cleaning module 60 when it is placed. On the other hand, they can make the rubbish through the cleaning module 60 move backward from the waterside end 153 through the flow channel 15, so that no rubbish is accumulated in the cleaning module 60. In addition, if the water inlet 12 is arranged in the rear, the filtration effect of the automatic pool cleaner will be better.

Please refer to FIG. 2 and FIG. 6, in some more specific embodiments, any tangent line on the cambered surface from the drainage surface 151 to the catchment end 154 is not parallel to the first plane. By making all tangent lines on the cambered surface from the drainage surface 151 to the catchment end 154 not parallel to the first plane, the flow process of water flowing through the flow channel 15 can be smoother, and the water flow can be attached to the bottom surface of the housing 10 where the flow channel 15 is located, so as to achieve the purpose of more uniform stress state when flowing through the flow channel 15.

Please refer to FIG. 2 and FIG. 6, in some specific embodiments, the catchment end 154 is a cambered structure protruding from the housing 10. It should be noted that in order to make water flow automatically converge to the water inlet 12, the inlet velocity should be reached fast to reduce the energy consumption of the water pump module 30 by arranging the catchment end 154 as a cambered structure protruding from the housing 10 and arranging the catchment end 154 in front of the water inlet 12 along the direction of travel of the automatic pool cleaner. Please refer to FIG. 2 and FIG. 6, in some more specific embodiments, any tangent line on the cambered surface from the drainage surface 151 to the catchment end 154 is inclined to the first plane at an angle greater than 0° and not greater than 65°. It should be noted that too small and too large an angle will increase the resistance of the water flow along the direction of travel, so the effect of better reducing the water flow resistance cannot be achieved. Therefore, the inclination angle of the flow channel 15 is set to be greater than 0° and not greater than 65° relative to the first plane.

Please refer to FIG. 6 and FIG. 8, in some embodiments, a guide plate 121 is formed by the water inlet 12 concave to the interior of the housing 10, and the inclination angle of the guide plate 121 ranges from 50° to 80° relative to the first plane.

Specifically, the guide plate 121 is formed by the water inlet 12 concave to the interior of the housing 10. The guide plate 121 is arranged to limit the flow direction when the water enters the interior of the housing 10 from the outside so that the water can directly flow to the filtering module 20, thus making the filtration effect better. In addition, by tilting the guide plate 121 relative to the direction of travel at an angle ranging from 50° to 80°, it is better able to bear the water flow near the water inlet 12, and the water still has a certain speed around the water inlet 12, thereby reducing the power of the water pump module 30 and reducing energy consumption.

In some embodiments, the inclination angle of the guide plate 121 ranges from 55° to 75° relative to the first plane. Such an angle range makes it easier for water near the water inlet 12 to enter the water inlet 12. The vertical height of the guide plate 121 is higher than the bottom plate of the filtering module 20 to facilitate garbage deposition.

Please refer to FIG. 2 and FIG. 4, in some embodiments, the automatic pool cleaner also includes at least two wheels (the drive module 50). The wheels (the drive module 50) define a plane, which is the first plane; The bottom of the housing 10 is concave inward to form a cavity area, and the top surface of the cavity area is higher than the first plane. Specifically, the bottom of the housing 10 is concave inward to form a cavity area, and the top surface of the cavity area is higher than the first plane, which can prevent the bottom of the housing 10 from being adsorbed on the surface of the pool by the water outlet 11 of the pool and cause the automatic pool cleaner cannot be tilted up, and at the same time, the operator can smoothly lift the automatic pool cleaner.

Please refer to FIG. 2 and FIG. 4, in some specific embodiments, the cavity area is also provided with a grille 16, and the length direction of the grille 16 is arranged along the direction of travel of the automatic pool cleaner. Specifically, the cavity area is also provided with a grille 16, and the length direction of the grille 16 is arranged along the direction of travel of the automatic pool cleaner. On the one hand, the grille 16 will not prevent the flow of water at the bottom of the housing 10, thereby increasing the resistance; on the other hand, the grille 16 can make the effect of preventing adsorption better. Please refer to FIG. 2 and FIG. 4, in some more specific embodiments, spacing between any two adjacent grilles 16 ranges from 30 mm to 40 mm. In some embodiments, the length of the water inlet 12 ranges from 150 mm to 175 mm.

Please refer to FIG. 2, FIG. 4 and FIG. 8, in some embodiments, the water inlet 12 is arranged at the bottom of the housing 10, and the bottom of the housing 10 is provided with a cleaning brush 61; Along the direction of travel of the automatic pool cleaner, the cleaning brush 61 is behind the water inlet 12. It should be noted that a cleaning brush 61 is arranged behind the water inlet 12, and the pool surface behind the water inlet 12 can be cleaned by the cleaning brush 61, making the pool surface cleaner. In addition, by providing a cleaning brush 61 in the rear, on the one hand, the rubbish not filtered into the water inlet 12 can be blocked; on the other hand, the rubbish cleaned behind the cleaning brush 61 can also enter the water inlet 12 and be filtered by the filtering module 20. Please refer to FIG. 2, FIG. 4, and FIG. 8, in some specific embodiments, the length of the cleaning brush 61 is not less than that of the water inlet 12, and the cleaning brush 61 is arranged side by side with the water inlet 12. Please refer to FIG. 2, FIG. 4, and FIG. 8, in some more specific embodiments, the distance between the cleaning brush 61 and the water inlet 12 ranges from 12 mm to 32 mm.

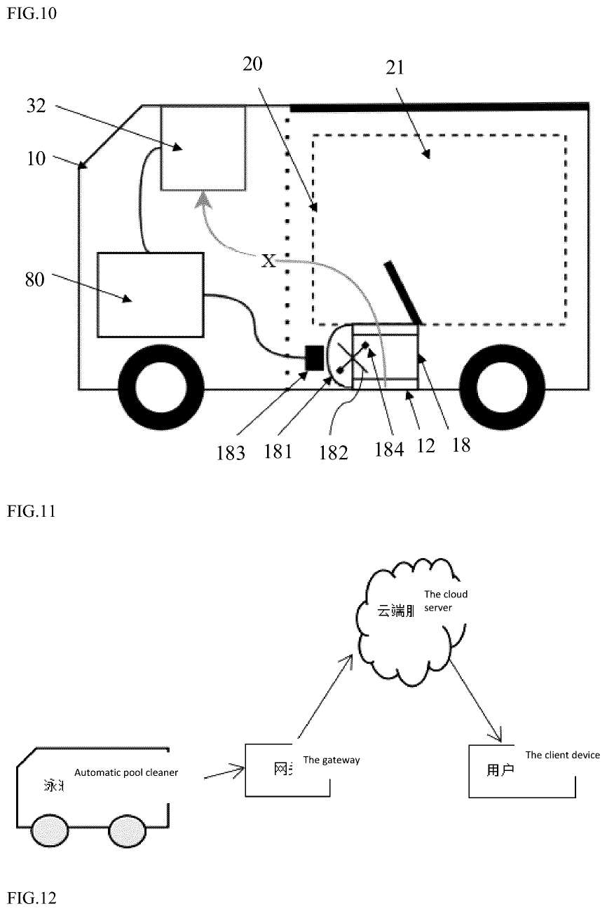

Please refer to FIG. 10 and FIG. 11, in some embodiments, specifically, for the housing 10 and the control module 80, a flow rate detection device, the filtering module 20 and the power pump 32 arranged in the housing 10, the control module 80 is connected with the flow velocity detection device, and the housing 10 is provided with the water inlet 12 and water outlet. The housing 10 is provided with the flow velocity detection device 18 communicated with the water inlet 12 and the water outlet, the filtering module 20 is arranged in the water flow passage 18, and the flow velocity detection device is at least partially arranged in the water flow passage 18.

Further, in the automatic pool cleaner of the present invention, the flow velocity detection device includes a first impeller 182 and a hall effect sensor 183. The control module 80 is connected with the hall effect sensor 183, and the power pump 32 and the first impeller 182 are at least partially arranged in the water flow passage 18; Among them, the water flow passage 183 is arranged near the first impeller 182, and at least one first magnetic component 184 corresponding to the hall effect sensor 183 is provided on the first impeller 182.

It can be seen from the above description that in the present invention, the inventor optimally designs a novel automatic pool cleaner. In the actual application of the automatic pool cleaner, the power pump 32 partially arranged in the water flow passage 18 can effectively pump the sewage from the water inlet 12 into the housing 10 and make the sewage flow in the water flow passage 18. Therefore, the sewage entering the water flow passage 18 can be filtered by the filtering module 20 and discharged from the water outlet; Among them, the arrow X in FIG. 10 and FIG. 11 both represent the flow path of the water flow. Different from the prior art, the automatic pool cleaner designed in the present invention is also equipped with the flow velocity detection device partially arranged in the water flow passage 18 in the housing 10 to detect the flow velocity in the water flow passage 18.

Among them, the flow velocity detection device designed by the present invention can specifically include the first impeller 182 and the hall effect sensor 183, wherein part of the first impeller 182 is arranged in the water flow passage 18, and at least one first magnetic component 184 is arranged on the first impeller 182. Thus, a low-cost, open flow meter is formed by combining the first impeller 182 with the hall effect sensor 183. The flow velocity detection device composed of the first impeller 182 and hall effect sensor 183 is simple in structure, easy to install, low in waterproof requirements, low in cost, easy to implement and high in reliability.

In the present invention, when the water flows in the water flow passage 18, it will push the first impeller 182 to rotate around its rotation axis. The higher the degree of blockage of the filtering module 20, the slower the flow velocity in the water flow passage 18, and the slower the rotation of the first impeller 182. Conversely, the lower the degree of blockage of the filtering module 20, the faster the flow velocity in the water flow passage 18, and the faster the rotation of the first impeller 182. Among them, when the first impeller 182 rotates around its rotation axis, the first magnetic component 184 installed on the first impeller 182 will periodically act on the hall effect sensor 183, making the hall effect sensor 183 periodically open. At this time, the control module 80 can calculate the rotation speed of the first impeller 182 by measuring the periodic pulse signal generated by the hall effect sensor 183, and then judge the current flow velocity in the water flow passage 18, so as to obtain the blockage of the filtering module 20 of the automatic pool cleaner.

It should be noted that in the present invention, the reason why the hall effect sensor 183 is arranged near the first impeller 182 is that the hall effect sensor 183 arranged near the first impeller 182 can ensure that when the first impeller 182 rotates around its rotation axis under the push of water flow, it can drive the first magnetic component 184 to pass through the induction range of the hall effect sensor 183. When the first magnetic component 184 passes through the induction range of the hall effect sensor 183, it can trigger the hall effect sensor 183 to generate a periodic pulse signal, the hall effect sensor 183 can transmit the pulse signal to the control module 80.

Accordingly, in the actual design of the automatic pool cleaner, the operator can also set a preset threshold in advance. When the rotation speed of the first impeller 182 calculated by the control module 80 according to the periodic pulse signal generated by the hall effect sensor 183 is greater than the preset threshold, the current flow rate of the automatic pool cleaner can be judged as normal to maintain the normal cleaning of the pool; Conversely, if the rotation speed of the first impeller 182 calculated by the control module 80 according to the periodic pulse signal generated by the hall effect sensor 183 is less than the preset threshold, the filtering module 20 of the current automatic pool cleaner can be judged to be blocked, and the user will be timely warned to clean the filtering module 20.

Further, in the automatic pool cleaner of the present invention, the first impeller 182 is arranged at the end of the water flow passage 18 near the water inlet 12 or the water outlet. Please refer to FIG. 10 and FIG. 11, in the technical solution of the present invention, in some specific embodiments, the first impeller 182 may be specifically arranged at one end of the water flow passage 18 near the water inlet 12 or the water outlet because the water flow near the water inlet 12 or the water outlet is more stable, so is the first impeller 182 around its rotation axis, so that the periodic pulse signal generated by the hall effect sensor 183 is more accurate, so as to facilitate the control module 80 to accurately judge the rotation speed of the current first impeller 182. In turn, the blockage degree of the filtering module 20 in the automatic pool cleaner can be more accurately reflected.

Further, in the automatic pool cleaner of the present invention, the first impeller 182 includes a rotating axis and a plurality of blades, and the plurality of impellers are connected with the rotation axis. The shape and size of the impeller are the same as those of the cross-sectional area of the water flow passage 18. Further, in the automatic pool cleaner of the present invention, two first magnetic components 184 are arranged on the first impeller 182, and the two first magnetic components 184 are respectively arranged on the two blades arranged relative to each other.

In the technical solution of the present invention, the designed first impeller 182 can include a rotation axis and a plurality of impellers, and these blades can be connected with the rotation axis so that when the first impeller 182 is rotating, all blades can rotate around the axis of the rotation axis. It should be noted that the reason why the shape and size of the blade are controlled the same as those of the cross-sectional area of the water flow passage 18 is that this setting can ensure that the shape of the blade is larger, which can facilitate the blade to more fully accept the impact of the water flow, so as to rotate.

Accordingly, please refer to FIG. 10 and FIG. 11, in some embodiments, the first impeller 182 may include the rotation axis and four blades connected with the rotation axis, which are uniformly arranged 90° from each other. In practical application, the two first magnetic components 184 can be specifically arranged on the first impeller 182, and the two first magnetic components 184 can be respectively arranged on two blades that are arranged relative to each other. Of course, in some other embodiments, more first magnetic components 184 may be arranged so that the first impeller 182 can trigger the hall effect sensor 183 more times when it rotates one cycle, so that the hall effect sensor 183 generates more signals, making it more sensitive, and ensuring that the speed of the first impeller 182 can be accurately measured even when the flow velocity in the water flow passage 18 is slow. It should be noted that the first blade 182 will rotate around its rotation axis driven by water flow. The higher the degree of blockage of the filtering module 20, the slower the flow velocity in water flow passage 18, and the slower the rotation of the first blade 182. At the same time, the first magnetic component 184 installed on the blade of the first impeller 182 will periodically act on the Hall inductor 183, making the Hall inductor 183 periodically open. At this time, the control module 80 can calculate the rotation speed of the first impeller 182 by measuring the periodic pulse signal generated by the hall effect sensor 183, and then judge the current flow velocity in the water flow passage 18, so as to obtain the blockage of the filtering module 20 of the automatic pool cleaner.

Assuming that n first magnetic components 184 are installed on the first blade 182, its one rotation cycle will trigger the hall effect sensor 183 to generate n pulse signals, and the pulse signal period of the hall effect sensor 183 measured by the control module 80 is t, then, the rotational speed w of the first impeller 182 is calculated as follows:

$$w = 60 / ( n * t )$$

Where, w represents the rotational speed of the impeller, unit: rpm (revolutions per minute), and t is the pulse signal period of the hall effect sensor 183 measured by the controller, unit: ms (milliseconds). Therefore, when the operator has pre-calibrated the mapping relationship between the impeller rotational speed w and the blockage degree of the filter, the blockage degree of the filter on the automatic pool cleaner can be determined according to the mapping relationship and the real-time acquisition of the impeller rotational speed w.

Further, in the automatic pool cleaner of the present invention, the water flow passage 18 is provided with a concave part 181, and the first impeller 182 is at least partially arranged in the concave part 181. Further, in the automatic pool cleaner of the present invention, at least half of the first impellers 182 are arranged in the concave part 181. In the technical solution of the present invention, the water flow passage 18 can also be provided with the concave part 181, and the first impeller 182 can be arranged at least partially in the concave part 181. The concave part 181 can block part of the water flow to prevent the technical problem that the first impeller 182 cannot rotate around its rotation axis due to the balanced force of the water flow on the first passage 182. Accordingly, in some embodiments, at least half of the first impellers 182 can also be preferably controlled to be located in the concave part 181 of the water flow passage 18 in the actual setup.

Further, in the automatic pool cleaner of the present invention, the water flow passage 18 also includes a detection channel. The cross-sectional area of the detection channel is smaller than that of the rest of the water flow passage 18, and the first impeller 182 is at least partially located in the detection channel. In the technical solution of the present invention, the reason why at least part of the first vane 182 is arranged in the detection channel and the cross-sectional area of the detection channel is controlled to be smaller than that of the other parts of the water flow passage 18 is that the cross-sectional area of the detection channel is the smallest, and the flow velocity of the water increases when passing through the detection channel, so that the water can obtain more kinetic energy to avoid the failure of water flow driving the first impeller 182 to rotate around its rotation axis.

Further, the automatic pool cleaner of the present invention also includes a warning device. The warning device is arranged on the housing 10, and is electrically connected with the control module 80; The warning device includes at least one of an indicator light, a buzzer, and a vibrator. Currently, after the automatic pool cleaner cleans for a period, the filtering module 20 becomes clogged due to the accumulation of fine dust, and causes a slow decrease in the amount of intake water and a decrease in the amount of drainage water, resulting in a continuous decrease in the cleaning ability of the automatic pool cleaner. If the pool is very dirty, the filtering module 20 of the automatic pool cleaner will soon be blocked, and the subsequent cleaning will be ineffective, which is easy to cause user complaints. Therefore, in the actual application of the automatic pool cleaner, the warning device can also be arranged on the automatic pool cleaner, and the warning device can include at least one of the indicators, buzzers, and vibrators. Once the control module 80 determines that the flow velocity in the water flow passage 18 is lower than the preset threshold based on the rotational speed of the first impeller 182 calculated by the periodic pulse signal generated by the hall effect sensor 183, the current filtering module 20 is judged to be blocked; At this time, the control module 80 can send a warning signal to the warning device, the indicator of the warning device is lit, the buzzer can sound the alarm, and the vibrator can start to vibrate to prompt the user to clean the filtering module 20 of the automatic pool cleaner in time.

Further, the automatic pool cleaner of the present invention also includes a communication device. The communication device is arranged in the housing 10, and is electrically connected with the control module 80. In the present invention, in order to facilitate the automatic pool cleaner to transmit itself to an external device in response to the blockage of the filtering module 20, in some embodiments, the automatic pool cleaner can also be provided with the communication device. The communication device is electrically connected with the control module 80 and can communicate wirelessly with the external device.

As shown in FIG. 12, accordingly, in the present invention, the inventor also designs a pool cleaning system, which includes: a client device, a cloud server and the automatic pool cleaner of the present invention. The automatic pool cleaner is directly or indirectly connected with the cloud server, and the client device is connected with the cloud server. As can be seen from the technical solution of the present invention, in practical application, the automatic pool cleaner can also be controlled to be directly or indirectly connected with the cloud server, so as to send the blockage of its filtering module 20 to the cloud server. At this time, the user can obtain the information of the cloud server by using the portable client device (mobile phone or tablet computer), which is, the blockage of the filtering module 20 of the automatic pool cleaner. It should be noted that in some cases, the automatic pool cleaner can directly communicate with the cloud server wirelessly, and in some embodiments, the automatic pool cleaner can also achieve an indirect communication connection with the cloud server through the gateway.

In the present embodiment, the automatic pool cleaner specifically includes the housing 10, the filtering module 20, the power pump 32, the control module 80, the communication device, and the flow velocity detection device arranged in the housing 10. The water inlet 12 and the water outlet are arranged on the housing 10, and the housing 10 is provided with the water flow passage 18 communicated with the water inlet 12 and the water outlet respectively. Among them, the flow velocity detection device includes the first impeller 182 and the hall effect sensor 183. The filtering module 20 is arranged in the water flow passage 18, and the first impeller 182 and the power pump 32 are at least partially arranged in the water flow passage 18. The hall effect sensor 183 is arranged near the first impeller 182, and the power pump 32, the communication device, and the hall effect sensor 183 is connected with the control module 80.

Accordingly, please further refer to FIG. 11, in the embodiment, the first impeller 182 in the flow velocity detection device specifically includes a rotation axis and four blades, and these four blades are all connected with the rotating axis. Among them, the two first magnetic components 184 are also arranged on the first impeller 182, and the two first magnetic components 184 are respectively arranged on the two blades relative to each other. As shown in FIG. 11, in the embodiment, the water flow passage 18 includes a detection channel located at one end of the water flow passage 18 near the water inlet 12, and the cross-sectional area of the detection channel is smaller than that of the rest of the water flow passage 18. Among them, in the embodiment, the detection channel is also provided with the concave part 181, so the first impeller 182 is fully arranged in the detection channel, and the first impeller 182 can be partially arranged in the concave part 181 of the detection channel.

In the embodiment, when the water flows in the water flow passage 18, it pushes the first impeller 182 to rotate around its rotation axis. The arrows X in FIG. 11 all represent the flow path of the water flow. The higher the degree of blockage of the filtering module 20, the slower the flow velocity in the water flow passage 18, and the slower the rotation of the first impeller 182. Conversely, the lower the degree of blockage of the filtering module 20, the faster the flow velocity in the water flow passage 18, and the faster the rotation of the first impeller 182. Among them, when the first impeller 182 rotates around its rotation axis, the first magnetic component 184 installed on the first impeller 182 will periodically act on the hall effect sensor 183, making the hall effect sensor 183 periodically open. At this time, the hall effect sensor 183 generates a periodic pulse signal. The control module 80 can calculate the rotation speed of the first impeller 182 by measuring the periodic pulse signal generated by the hall effect sensor 183, and then judge the current flow velocity in the water flow passage 18, so as to obtain the blockage of the filtering module 20 of the automatic pool cleaner.

Before the actual application of the automatic pool cleaner in embodiment I, a threshold should be set in advance. When the rotation speed of the first impeller 182 calculated by the control module 80 according to the periodic pulse signal generated by the hall effect sensor 183 is greater than the preset threshold, the current flow rate of the automatic pool cleaner can be judged as normal to maintain the normal cleaning of the pool; Conversely, if the rotation speed of the first impeller 182 calculated by the control module 80 according to the periodic pulse signal generated by the hall effect sensor 183 is less than the preset threshold, the filtering module 20 of the current automatic pool cleaner can be judged to be blocked.

When the automatic pool cleaner starts to work, the power pump 32 can pump water from the water inlet 12 into the housing 10. After the water enters the housing 10, it will flow along the water flow passage 18, and after being filtered by the filtering module 20, it will be discharged from the water outlet, and the filtered waste will enter the containing structure 21. During the operation of the automatic pool cleaner, the flow rate and velocity will be generated when the water flows in the water flow passage 18, and the water flow in the water flow passage 18 will push the first impeller 182 to rotate around its rotation axis, so that the two first magnetic components 184 installed on the first impeller 182 will periodically act on the hall effect sensor 183, making the hall effect sensor 183 periodically open and generate pulse signals. At this time, the control module 80 can calculate the rotational speed of the first impeller 182 by measuring the periodic pulse signal generated by the hall effect sensor 183.

Once the control module 80 determines that the rotational speed of the first impeller 182 is lower than the preset threshold based on the periodic pulse signal generated by the hall effect sensor 183, the current filtering module 20 of the automatic pool cleaner is judged to be blocked now; At this time, the control module 80 can send an alarm signal to the warning device, the indicator of the warning device is lit, the buzzer can sound the alarm, and the vibrator can start to vibrate to prompt the user to clean the filtering module 20 of the automatic pool cleaner in time.

In practical application, the control module 80 can send the degree of blockage information of the filtering module 20 of the current automatic pool cleaner to the cloud server in real-time through the communication device, and the user can wirelessly communicate with the cloud server through the client device, which is, can receive the degree of blockage information of the filtering module 20 of the current automatic pool cleaner from the client device. For example: When the filtering module 20 is blocked, the control module 80 can send the blocking signal to the gateway on the shore through the communication module, and then send the blocking signal of the relevant filtering module 20 to the cloud server through the gateway connected to the cloud server. The cloud server will store it and finally send it to the client device to warn the user that the filtering module 20 of the automatic pool cleaner needs to be cleaned.

In summary, it can be seen that in the present invention, the inventor optimally designs a novel automatic pool cleaner, wherein the first impeller 182 and the hall effect sensor 183 are added to the automatic pool cleaner, so as to use the first impeller 182 and the hall effect sensor 183 together to form a low-cost and open flow meter. The simple flowmeter composed of the first impeller 182 and the hall effect sensor 183 is simple to install, with low waterproof requirements, low cost, easy to implement, and reliable function. The hall effect sensor 183 can generate periodic pulse signals when the first impeller 182 with the first magnetic component 184 rotates. The control module 80 can calculate the rotational speed of the first impeller 182 according to the periodic pulse signal generated by the automatic pool cleaner 183, so as to monitor the flow velocity in the water flow passage 18 through the rotational speed of the first impeller 182, and judge the blockage degree of the filtering module 20 of the automatic pool cleaner according to the flow velocity in the water flow passage 18.

Please refer to FIG. 13-FIG. 19. the automatic pool cleaner also includes the out-of-water detection module located at one end of the housing 10. The out-of-water detection module includes the floating unit 41 and the sensing unit 42. The floating unit 41 can move between the first and the second position. When the floating unit 41 is in the first position, the sensing unit 42 sends the first signal; When the floating unit 41 is in the second position, the sensing unit 42 sends a second signal. By arranging the out-of-water detection module at one end of the housing 10, the automatic pool cleaner can be detected by the out-of-water detection module when it is just above the pool waterline, so the judgment of whether the automatic pool cleaner is out of water is more sensitive. The out-of-water detection module includes the floating unit 41 and the sensing unit 42, which can change the magnitude and presence of buoyancy force on the floating unit 41 to make the floating unit 41 move between the first and the second positions according to whether the pool cleaner is out of the waterline, and then identify the position of the floating unit 42 through the sensing unit 41 to send the first signal or the second signal to the automatic pool cleaner, so as to judge whether the automatic pool cleaner is above the water surface. Compared with the prior art, the automatic pool cleaner disclosed in the application can realize the purpose of accurately judging whether the automatic pool cleaner is out of the water surface of the pool.

In some embodiments, the out-of-water detection module is connected with the water pump module 30 signal. Through the first signal/second signal emitted by the out-of-water detection module, the water pump module 30 outputs different power. Obviously, in other embodiments, the out-of-water detection module can also be used to determine whether the automatic pool cleaner is above the water surface, which can be combined with other technical means to achieve other operations.

The out-of-water detection module includes the floating unit 41 and the sensing unit 42. Among them, for the floating unit 41, the floating unit 41 refers to an object capable of reacting to the buoyancy of a water body, such as a buoyancy block. It should be explained that the reaction to the buoyancy of the water body does not limit that the floating unit 41 must float on the water surface, and the floating unit 41 can also be suspended in water. For example, the floating unit 41 is a buoyancy ball, and the buoyancy ball filled with water can float in the water body when it is placed in the water. When there is no water around the buoyancy ball, the buoyancy ball will naturally fall to the bottom, so the movement between the first position and the second position is realized. At this time, the sensing unit 42 is the pressure sensor for the pressure of the buoyancy ball naturally falling to the bottom to determine the position of the automatic pool cleaner according to the magnitude of pressure.

It should be noted that the present invention does not limit the location of the out-of-water detection module arranged outside or inside the housing 10, and the number of the out-of-water detection module. The out-of-water detection module arranged at one end of the housing 10 means that the out-of-water detection module can be arranged at the upper, lower, front, back, left, or right end of the housing 10, because some types of automatic pool cleaners can move in multiple directions, resulting in the first position above the water surface may not be the front end of the housing 10. In addition, by changing the attitude of the out-of-water detection module, the automatic pool cleaner above the water surface limited can be warned, and the specific attitude of the automatic pool cleaner when it is above the water surface can be judged by setting multiple out-of-water detection modules.

In some embodiments, the floating unit 41 always maintains the same attitude relative to the water surface. The floating unit 41 has a first attitude and a second attitude relative to the sensing unit 42. The sensing unit 42 emits a third signal when the floating unit 41 is in the first attitude, and the sensing unit 42 emits a fourth signal when the floating unit 41 is in the second attitude. Through the first and second attitudes of the floating unit 41, the attitude of the automatic pool cleaner can be judged. For example, the floating unit 41 is a plate-shaped buoyancy block that is always parallel to the water surface. When the automatic pool cleaner is placed flat in the pool, if the sensing unit 42 is arranged directly below the buoyancy block, the profile of the buoyancy block recognized by the sensing unit 42 is the front profile of the plate-shaped buoyancy block, and this attitude is the first attitude; When the automatic pool cleaner is placed vertically in the pool, the buoyancy block will always be parallel to the water surface, but the sensing unit 42 will change with the attitude of the automatic pool cleaner, so that the profile of the buoyancy block recognized by the sensing unit 42 at this time is the profile of the side thickness of the plate-shaped buoyancy block, and this attitude is the second attitude. The sensing unit 42 can be two sensors arranged in two different directions or capture cameras, etc.

Please refer FIG. 13, in some embodiments, the floating unit 41 is the buoyancy block, and the sensing unit 42 is the position sensor. The buoyancy block moves between the first position and the second position according to the buoyancy force imposed on it, and the position sensor is arranged on the motion path of the buoyancy block. It should be noted that the floating unit 41 is the buoyancy block, and the sensing unit 42 is the position sensor. The position sensor arranged on the moving path of the buoyancy block means that the position sensor can realize the position monitoring of the buoyancy block, and it recognizes the difference in the moving path of the buoyancy block. In some embodiments, the position sensor is an optical position sensor. The optical path of the optical position sensor passes through the moving path of the buoyancy block, and the optical position sensor can recognize when its optical path is blocked by the buoyancy block. Specifically, the out-of-water detection module also includes a slide rod. The slide rod is fixedly connected the housing 10, the buoyancy block is connected with the slide rod in a sliding manner, and the position sensor is at the bottom of the slide rod. The position sensor is used to detect the position of the buoyancy block on the slide rod during the movement of the automatic pool cleaner to realize the out-of-water detection of the automatic pool cleaner.

When the automatic pool cleaner moves underwater and the water surface is higher than the top of the slide rod, the buoyancy block is continuously on the top of the slide rod under the action of buoyancy. When the automatic pool cleaner continues to move upward and the water surface is between the top and bottom of the slide rod, the buoyancy block slides vertically down along the slide rod under the action of water buoyancy and its own gravity. When the robotic pool continues to move upward and the water surface does not exceed the bottom of the slide rod, the buoyancy block is at the bottom of the slide rod under its own gravity, and the position sensor detects the position of the buoyancy block and sends out the corresponding first signal. It should be explained that when the buoyancy block is in other positions, the position sensor sends out the second signal. In addition, the position sensor can be arranged at different positions of the slide rod to realize the emission of the second signal.

In some embodiments, the sensing unit 42 emits the first signal when the floating unit 41 is continuously in the first position. Thus, the judgment of whether the automatic pool cleaner is above the water surface is more accurate. It should be noted that the period of the floating unit 41 continues to be in the first position is a few seconds, so that the judgment of whether the automatic pool cleaner is above the water surface is not too delayed.

Among them, the application can use “the stop emission of the first signal” as the second signal. Taking the above embodiment as an example, when the buoyancy block is at the bottom of the slide rod under its own gravity, the first signal is emitted, and when the buoyancy block is not at the bottom of the slide rod, “the stop emission of the first signal” is used as the second signal. It should be noted that at this time, the first signal needs to be continuously emitted to make an accurate judgment on whether the automatic pool cleaner is above the water surface, especially in the scenery where the automatic pool cleaner needs to enter and exit the waterline frequently. In other embodiments, the sensing unit 42 may also be a camera unit. The sensing unit 42 can also be monitored remotely.

In some embodiments, the floating unit 41 is the buoyancy block, and the sensing unit 42 is an angle sensor. The buoyancy block is rotationally connected to the housing 10, the buoyancy block swings between the first and second positions according to the buoyancy imposed on it, and the angle sensor detects the swing angle of the buoyancy block and emits the first/second signal.

Specifically, the out-of-water detection module also includes a pendulum rod and a limit block. One end of the pendulum rod is rotationally connected with the housing 10, and the other end is connected with the buoyancy block. The limit block is fixed on the housing 10, and is on the rotating stroke of the pendulum rod to limit the rotation angle of the pendulum rod. The angle sensor is connected with the rotating shaft of the pendulum rod and detects the rotation angle of the pendulum rod driven by the buoyancy block during the movement of the automatic pool cleaner, so as to realize the out-of-water detection of the automatic pool cleaner.

When the automatic pool cleaner moves underwater and the water surface is higher than the highest position that the buoyancy block can reach, the buoyancy block continues to be in the highest position under the action of buoyancy, and the swinging arm is at the maximum angle; When the automatic pool cleaner continues to move upward and the water surface is between the highest position and the lowest position the buoyancy block can reach, the angle of the pendulum rod decreases under the action of the buoyancy force of the water and its gravity. When the automatic pool cleaner continues to move upward and the water surface does not exceed the lowest position of the buoyancy block, the buoyancy block is in the lowest position under its gravity, and the angle sensor detects the position of the buoyancy block and sends the corresponding first signal at this time.

In some embodiments, the floating unit 41 is the buoyancy block, and the sensing unit 42 is the Hall sensor. The out-of-water detection module also includes a magnetic element, wherein one of the Hall sensor and the magnetic element is connected with the buoyancy block, and the other is connected with the housing 10. The buoyancy block is rotationally connected with the housing 10. The buoyancy block swings between the first and the second positions according to the different buoyancy imposed, while the Hall sensor and magnetic element are connected/disconnected with the swing angle of the buoyancy block.

Specifically, the out-of-water detection module also includes a magnetic element, a pendulum rod, and a limit block. One end of the pendulum rod is rotationally connected with the housing 10, and the other end is connected with the buoyancy block. The limit block is fixed on the housing 10 and is on the rotating stroke of the pendulum rod to limit the rotation angle of the pendulum rod. The Hall sensor is fixed with the housing 10 and is at the lowest position of the buoyancy block. The Hall sensor is used to detect whether the buoyancy block drives the magnetic element near or far away during the movement of the automatic pool cleaner to make a connection/disconnection between the Hall sensor and the magnetic element, and further realize the out-of-water detection of the automatic pool cleaner.

Please refer to FIG. 1 to FIG. 5, in some embodiments, the out-of-water detection module also includes: the drive module 50, which drives the movement of the automatic pool cleaner; The control module 80, which is connected with the drive module 50 by signals together with the out-of-water detection module. The control module 80 also receives the first/second signal emitted by the sensing unit 42 and controls the start and stop of the drive module 50. Specifically, by providing the drive module 50 and the control module 80, the control module 80 can receive the first/second signal sent by the sensing unit 42, and control the drive module 50 to open and close through the first/second signal, so that the automatic pool cleaner can accurately move up and down near the waterline on the side wall of the pool, thus realizing a better cleaning effect and more thorough cleaning of debris. The water pump module 30 in the application is communicated with the filtering module 20, and its function is to provide suction to suck the water in the pool from the water inlet 12 and then spray out from the water outlet 11 after passing through the filtering module 20 to filter the pool water. In some embodiments, the water sprayed from the water outlet 11 forms a backward recoil force, which can create downward pressure to make the automatic pool cleaner fit the surface of the pool.

The automatic pool cleaner with available out-of-water detection as shown in FIG. 13 includes the housing 10, a walking wheel set 51, a filter chamber 23, a detection device, a control device, a first sealed bin 333, and the water outlet 11. The detection device provided on the automatic pool cleaner, namely, the out-of-water detection module, is used to detect whether the body is out of the water by detecting its position when the automatic pool cleaner cleans the water line while cleaning the pool wall or the bottom of the pool, so as to avoid it above the water surface and inhale a lot of air, affecting the automatic pool cleaner's water and pollution uptake, and improving the cleaning efficiency and effect.

Specifically, the walking wheel set 51 includes two sets of wheels mounted on the bottom of the housing 10 for driving the movement of the housing 10.

Specifically, the filter chamber 23 is arranged inside the housing 10 and at the bottom of the housing 10; The filter chamber 23 includes:

the water inlet 12 arranged at the bottom of the filter chamber 23 and between the walking wheel set 51; the water inlet 12 communicated with the filter chamber 23 and separated from the outside and the first bin cover 25; The filter screen 24 arranged on the top of the filter chamber 23 and used to filter the rubbish in the pool water and collect it into the filter chamber 23.

Specifically, the detection device, that is, the out-of-water detection module is installed on the housing 10 for detecting whether the housing 10 is out of water.

In the present embodiment, the detection device includes a slide rod detecting device. The slide rod detection device includes a slide rod 411, which is arranged on the top of the housing 10; The first buoyancy block 411, which sliding connected to the slide rod 411; The position sensor 421, which is, the sensing unit 42, arranged at the end of the slide bar 411 near the water outlet 11 and used to detect the position of the first buoyancy block 411 on the slide rod 411. By setting a slide rod detection device, the position sensor 421 is used to detect the position of the first buoyancy block 411 on the slide rod 411 in the process of cleaning the pool wall to make the out-of-water detection of the automatic pool cleaner to prevent it from exceeding the water level.

Specifically, the first sealed bin 333 is arranged inside the housing 10 and is above the filter chamber bin 23. Specifically, the water outlet 11 is arranged inside the housing 10 and at the same level as the first sealed bin 333; The water outlet 11 is communicated with the outside and used for spraying water filtered by the filter screen 24 into the housing 10. Specifically, the control device installed in the first sealed bin 333, can achieve a better seal on the control device and prevent contact of water for the control module 80.

The control device includes a motor 33 with its output shaft 331 penetrating through the first sealed bin 333, extending to the water outlet 11 and dynamically connected with the first sealed bin 333; The impeller installed on the output shaft 331, which is used to drive the water ejection in the housing 10; The control module 80 electrically connected with the motor 33 and the detection device respectively, which is used to drive the second impeller 332 on the output shaft 331 to rotate and drive the housing 10 to move, and receive the water detection signal sent by the detection device and send an alarm.

In the embodiment, the position sensor 421 includes any of a Hall sensor, an optoelectronic switch, or a microswitch.

The embodiment also provides an out-of-water detection method for the automatic pool cleaner with available out-of-water detection. The position of the automatic pool cleaner when cleaning the pool wall is detected to determine whether the automatic pool cleaner is out of the water, and then the position detection is used to determine whether the automatic pool cleaner is out of the water to ensure that the automatic pool cleaner does not overstep the waterline and always cleans the pool wall or bottom, thus, improving the cleaning efficiency and cleaning effect of the automatic pool cleaner.

Among them, position detection is to detect the position of the first buoyancy block 411 on the slide rod 411 when the pool wall is cleaned by the automatic pool cleaner, which is used to detect whether the housing 10 is out of water.

When position detection is performed, the control device controls the automatic pool cleaner to move vertically up the pool wall, including the following steps in the specific process:
S1: When the automatic pool cleaner moves underwater and the water surface is higher than the top of the slide rod 411, the first buoyancy block 411 is continuously on the top of the slide rod 411 under the action of buoyancy;
S2: When the automatic pool cleaner continues to move upward and the water surface is between the top and bottom of the slide rod 411, the first buoyancy block 411 slides vertically down along the slide rod 411 under the action of water buoyancy and its gravity;
S3: When the automatic pool cleaner continues to move upward and the water surface does not exceed the bottom of the slide rod 411, the first buoyancy block 411 continues to stay at the bottom of the slide rod 411 under its gravity, and the position sensor 421 detects the position of the first buoyancy block 411 to identify the water signal of the automatic pool cleaner and send an alarm.

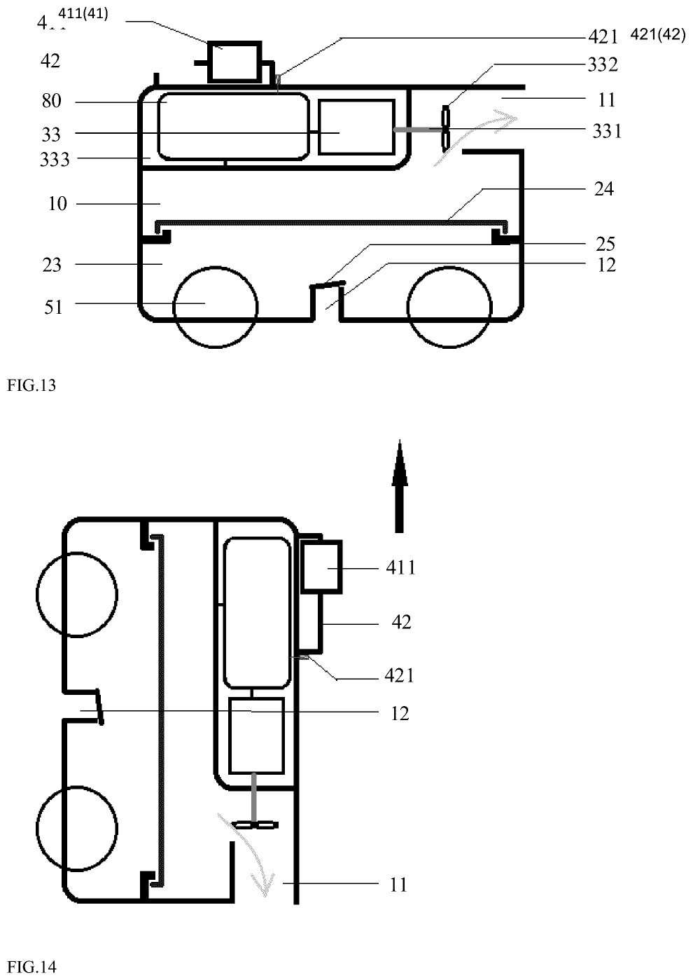

Among them, FIG. 14 shows the schematic diagram when the cleaner moves vertically upward and is underwater during the cleaning of the pool wall. FIG. 15 shows the schematic diagram when the cleaner moves vertically up and beyond the waterline while cleaning the pool wall.

### Embodiment 2

The embodiment provides an automatic pool cleaner with available out-of-water detection, including the housing 10, a walking wheel set 51, a filter chamber 23, a detection chamber 43, a detection device, a control device, a first sealed bin 333, and the water outlet 11. The detection device provided on the automatic pool cleaner is used to detect whether the body is out of the water by detecting its angle when the automatic pool cleaner cleans the water line while cleaning the pool wall or the bottom of the pool, so as to avoid it above the water surface and inhale a lot of air, affecting the automatic pool cleaner's water and pollution uptake, and improving the cleaning efficiency and effect.

Specifically, the walking wheel set 51 includes two sets of wheels mounted on the bottom of the housing 10 for driving the movement of the housing 10.

Specifically, the filter chamber 23 is arranged inside the housing 10 and at the bottom of the housing 10; The filter chamber 23 includes:

the water inlet 12 arranged at the bottom of the filter chamber 23 and between the walking wheel set 51; the water inlet 12 communicated with the filter chamber 23 and separated from the outside and the first bin cover 25; The filter screen 24 arranged on the top of the filter chamber 23 and used to filter the rubbish in the pool water and collect it into the filter chamber 23.

Specifically, the detection chamber 43 is arranged inside the housing 10 and on the top of the housing 10; The detection chamber 43 is provided with a detection port 44 and communicated with the outside; The detection chamber 43 is arranged at the same level as the first sealed bin 333 and the water outlet 11, and is arranged at one end away from the water outlet 11; Specifically, the detection device, which is mounted on the housing 10, is used to detect whether the housing 10 is out of water.

In the embodiment, the detection device includes a pendulum rod detection device. The pendulum rod detection device is installed in the detection chamber 43; The pendulum rod detection device includes: a pendulum rod 45, with one end connected with the inner wall of the detection chamber 43, and the other end rotated around the connection point connected with the inner wall of the detection chamber 43; The second buoyancy block 412 arranged at one end of the pendulum rod 45 away from the connection point; The limit block 46 fixed on the inner wall of the detection seal 43 and on the rotation stroke of the pendulum rod 45, which is used to limit the rotation angle of the pendulum rod 45; The angle sensor 422 arranged at the connection point to detect the rotation angle of the pendulum rod 45. The second buoyancy block 412 is arranged on the pendulum rod 45 by mounting the pendulum rod detection device to reduce the influence of friction during the rotation of the pendulum rod 45 and then effectively avoid the failure caused by jamming during the rotation process. At the same time, the angle sensor 422 is used to detect the rotation angle of the pendulum rod 45 in the process of cleaning the pool wall or the bottom of the pool to make the out-of-water detection of the automatic pool cleaner to avoid exceeding the water level.

Specifically, the first sealed bin 333 is arranged inside the housing 10 and is above the filter chamber bin 23. Specifically, the water outlet 11 is arranged inside the housing 10 and at the same level as the first sealed bin 333; The water outlet 11 is communicated with the outside and used for spraying water filtered by the filter screen 24 into the housing 10. Specifically, the control device installed in the first sealed bin 333, can achieve a better seal on the control device and prevent contact of water for the control module 80.

The control device includes a motor 33 with its output shaft 331 penetrating through the first sealed bin 333, extending to the water outlet 11 and dynamically connected with the first sealed bin 333; The impeller installed on the output shaft 331, which is used to drive the water ejection in the housing 10; The control module 80 electrically connected with the motor 33 and the detection device respectively, which is used to drive the second impeller 332 on the output shaft 331 to rotate and drive the housing 10 to move, and receive the water detection signal sent by the detection device and send an alarm. In the embodiment, the angle sensor 422 includes any of a Hall sensor, an optoelectronic switch, or a microswitch.

The embodiment also provides an out-of-water detection method for the automatic pool cleaner with available out-of-water detection. The angle of the automatic pool cleaner when cleaning the pool wall or bottom is detected to determine whether the automatic pool cleaner is out of the water to ensure that the automatic pool cleaner does not overstep the waterline through angle detection and always cleans the pool wall or bottom, thus, improving the cleaning efficiency and cleaning effect of the automatic pool cleaner.

Among them, angle detection is to detect the rotation angle of the pendulum rod 45 when the automatic pool cleaner cleans the wall or the bottom of the pool, which is used to detect whether the housing 10 is out of water.

When angle detection is performed, the control device controls the automatic pool cleaner to move vertically up the pool wall or move horizontally along the bottom of the pool, including the following steps in the specific process:
T1: When the automatic pool cleaner moves underwater and the water surface is higher than the limit block 46, the second buoyancy block 412 on the pendulum rod 45 continues to offset the pendulum rod 45 with the limit block 46 under the action of buoyancy;
T2: When the automatic pool cleaner continues to move upward along the pool wall or horizontally along the bottom of the pool, and the water surface is between the bottom of the limit block 46 and the pendulum rod 45, the second buoyancy block 412 on the pendulum rod 45 rotates around the connection point of the pendulum rod 45 away from the limit block 46 under the action of water buoyancy and its gravity;
T3: When the automatic pool cleaner continues to move upward along the pool wall or horizontally along the bottom of the pool, and the water surface does not exceed the bottom of the pendulum rod 45, the second buoyancy block 412 on the pendulum rod 45 will keep the pendulum rod 45 in a vertical downward or horizontal state under the action of its gravity, and the angle sensor 422 detects the rotation angle of the pendulum rod 45 to identify the out-of-water signal of the automatic pool cleaner and issue an alarm.

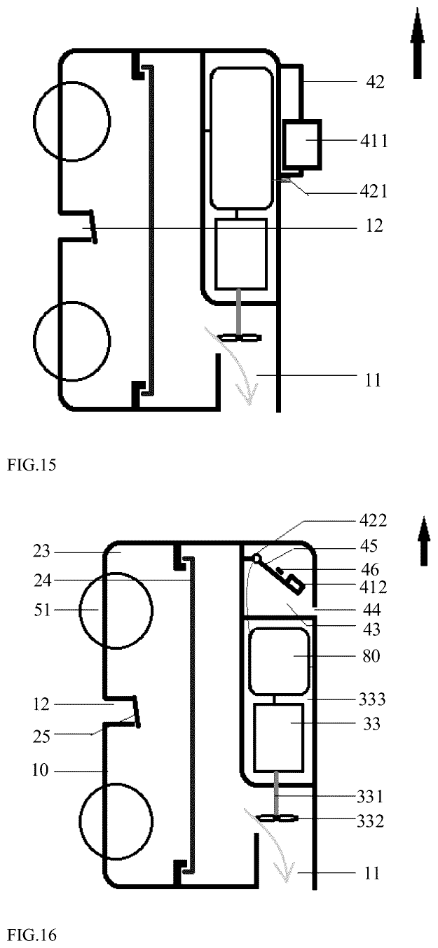

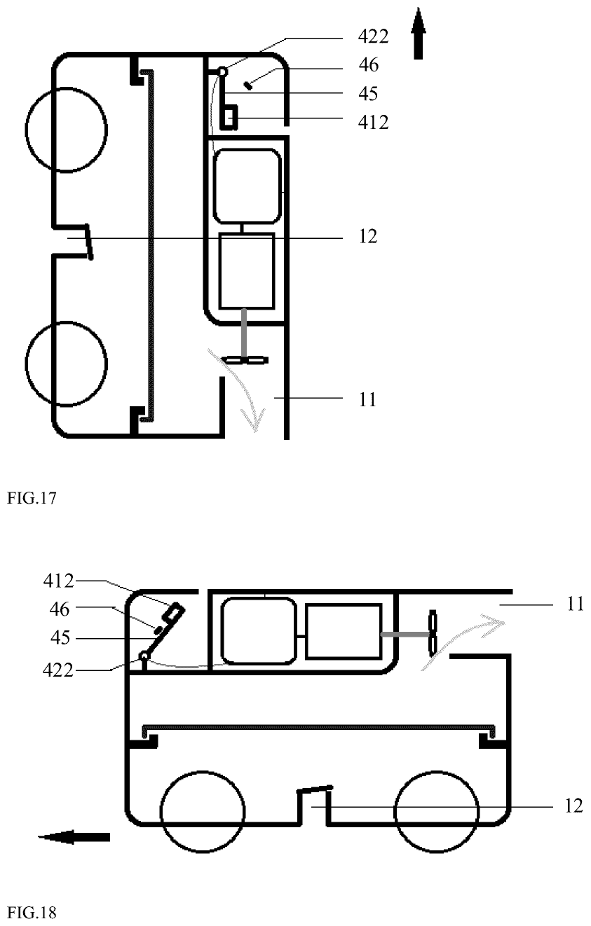

Among them, FIG. 16 shows the schematic diagram when the cleaner moves vertically upward and is underwater during the cleaning of the pool wall. FIG. 17 shows the schematic diagram when the cleaner moves vertically up and beyond the waterline while cleaning the pool wall.

FIG. 18 shows the schematic diagram when the cleaner moves horizontally and is underwater while cleaning the bottom of the pool. FIG. 19 shows the schematic diagram when the cleaner moves horizontally and above the water line while cleaning the bottom of the pool.

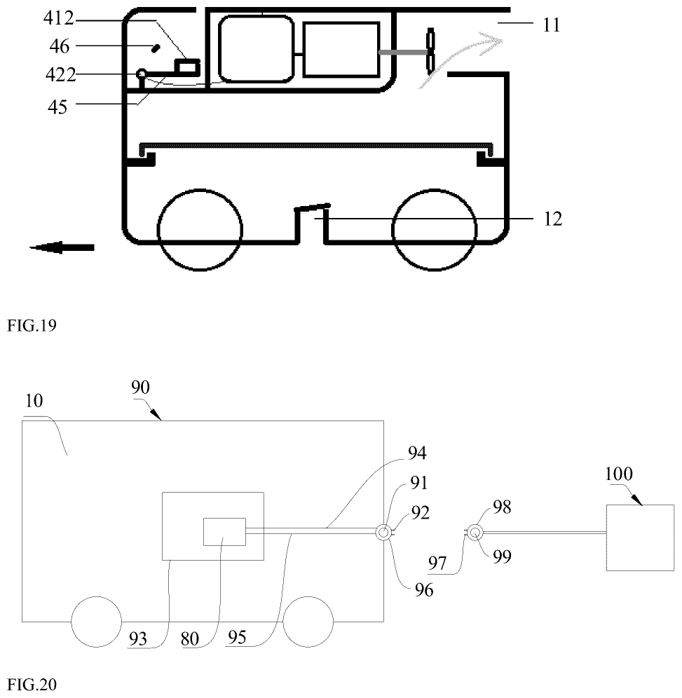

Please refer to FIG. 20, an automatic pool cleaner includes a main body 90 and a controllable magnetic component 91 arranged on the main body 90. The main body 90 is provided with a charging interface 92, and the controllable magnetic component 91 is arranged near the charging interface 92. The controllable magnetic element 91 is configured to be able to switch between magnetic and non-magnetic states.

It can be seen from the above description that the beneficial effects of the present invention are: The automatic pool cleaner has a novel structure and can quickly connect with the external interface 97 of the external charger 100. Compared with the solution of setting a permanent magnet on the automatic pool cleaner, the controllable magnetic component 91 does not absorb ferromagnetic impurities such as iron scraps when the automatic pool cleaner is working. The user does not need to clean the automatic pool cleaner frequently, which is conducive to enhancing the user experience. Also, the charging interface 92 does not have the problem of poor contact with the external interface 97 caused by the adsorption of ferromagnetic impurities to ensure the stable charging of the automatic pool cleaner.

The charging system includes an external charger 100 and an automatic pool cleaner.

In some embodiments, the automatic pool cleaner includes a main body 90 and a controllable magnetic element 91 arranged on the main body 90. The main body 90 is provided with a charging interface 92, and the controllable magnetic component 91 is arranged near the charging interface 92. The controllable magnetic element 91 is configured to be able to switch between magnetic and non-magnetic states. The controllable magnetic component 91 is at least one of the electro permanent magnet, ordinary electromagnet, latching electromagnet, and power loss type electromagnet; The main body 90 is provided with a control module 80 electrically connected with the controllable magnetic component 91, and the control module 80 is used to control the controllable magnetic element 91 to switch between magnetic and non-magnetic states. The external charger 100 has a magnetic structural member 98. The magnetic structural member 98 is provided with a permanent magnet 99 magnetically connected with the controllable magnetic component 91 and an external interface 97 for connection with the charging interface 92.

This embodiment takes the automatic pool cleaner as an example for illustration (that is, the automatic pool cleaner in this embodiment is the automatic pool cleaner). The main body 90 includes a housing 10, a pump, a battery, and a filter. The housing 10 is provided with a water inlet and a water outlet, and a water flow passage communicated with the water inlet and the water outlet is arranged in the housing 10. The water pump and the filter are arranged in the water flow passage, the controllable magnetic component 91 is arranged on the housing 10, and the battery is installed on the housing 10. The battery is directly or indirectly electrically connected with the charging interface 92.

Specifically, the housing 10 is provided with a second sealed bin 93, and the battery and the control module 80 are respectively arranged in the second sealed bin 93. The battery is indirectly electrically connected with the charging interface 92 through the control module 80. The control module 80 includes a main control board, and the main control board is electrically connected with the charging interface 92 through the first connection line 94 and electrically connected with the controllable magnetic component 91 through the second connection line 95.

Optionally, a charging structural member 96 is arranged on the housing 10. The charging interface 92 and the controllable magnetic component 91 are arranged on the charging structural member 96, and the charging structural member 96 is sealed connected with the housing 10.

When the control module 80 detects that the charging interface 92 is connected with the external interface 97, the controllable magnetic component 91 is controlled to switch to the magnetic state; When the control module 80 detects that the charging interface 92 is disconnected from the external interface 97, the controllable magnetic part 91 is controlled to switch to the non-magnetic state. Optionally, the controllable magnetic component 91 does not exhibit magnetic properties when powered on and exhibits magnetic properties when powered off. In detail, when the automatic pool cleaner is turned on and enters a charging current detection state, if no charging current is detected, the main control board will energize the controllable magnetic component 91, and the controllable magnetic part 91 will be unmagnetized at this time (the controllable magnetic component 91 selected at this time is an electro permanent magnet). The automatic pool cleaner can normally enter the water and work, and the controllable magnetic part 91 is energized all the time. At this time, because the controllable magnetic component 91 is unmagnetized, the controllable magnetic component 91 will not absorb ferromagnetic impurities. When the automatic pool cleaner is taken ashore, it will automatically shut down through detection (under normal mode, the automatic pool cleaner cannot be charged when it is started, and an alarm will be issued). At this time, after the automatic pool cleaner is shut down, the main control board will not energize the controllable magnetic component 91, and the controllable magnetic component 91 will immediately exhibit magnetic properties. The charging interface 92 can be normally connected and charged with the external interface 97 of the external charger 100. Because the controllable magnetic component 91 does not absorb ferromagnetic impurities such as iron scraps in the water, the automatic pool cleaner can use the charging interface 92 for stable charging.

Of course, the controllable magnetic component 91 does not exhibit magnetic properties when powered on and exhibits magnetic properties when powered off, which is also feasible. Specifically, when the automatic pool cleaner is turned on and enters a charging current detection state, if no charging current is detected, the main control board will not energize the controllable magnetic component 91, and the controllable magnetic component 91 will be unmagnetized at this time (the controllable magnetic component 91 selected at this time is an ordinary electromagnet, etc.). The automatic pool cleaner can normally enter the water and work, and the controllable magnetic part 91 is not energized all the time. At this time, because the controllable magnetic component 91 is unmagnetized, the controllable magnetic component 91 will not absorb ferromagnetic impurities. When the automatic pool cleaner is taken ashore, it will automatically shut down through detection. At this time, after the automatic pool cleaner is shut down, the main control board will energize the controllable magnetic component 91 within a preset period, and the controllable magnetic component 91 will exhibit magnetic properties. The charging interface 92 can be normally connected and charged with the external interface 97 of the external charger 100. Because the controllable magnetic component 91 does not absorb ferromagnetic impurities such as iron scraps in the water, the automatic pool cleaner can use the charging interface 92 for stable charging. It should be noted that in the process of charging the automatic pool cleaner, the control method may not be the above two, and other control methods can be used, such as the automatic pool cleaner does not automatically shut down after landing, and the automatic pool cleaner can be charged when powered on.

In some embodiments, the charging interface 92 may be a wireless interface, and the wireless interface can enable wireless charging of the automatic pool cleaner, which is conducive to improving the tightness and charging safety of the automatic pool cleaner. Specifically, the wireless interface is a wireless charging receiving module. However, in order to enable the automatic pool cleaner to charge stably and efficiently, in the embodiment, the charging interface 92 is a terminal interface, and the terminal interface can be either an elastic conductive part with a contact area, such as a shrapnel, an elastic probe, etc., or a hard conductive part with a contact area, such as a metal sheet.

In summary, the automatic pool cleaner and charging system provided by the present invention have a novel structure. The automatic pool cleaner will not absorb any iron scraps and other ferromagnetic impurities when working underwater/on the water surface and can realize accurate alignment with the external interface of the external charger when charging, so that the user can quickly charge the automatic pool cleaner. Later, the user does not need to frequently clean the automatic pool cleaner, which is conducive to enhancing the user experience.

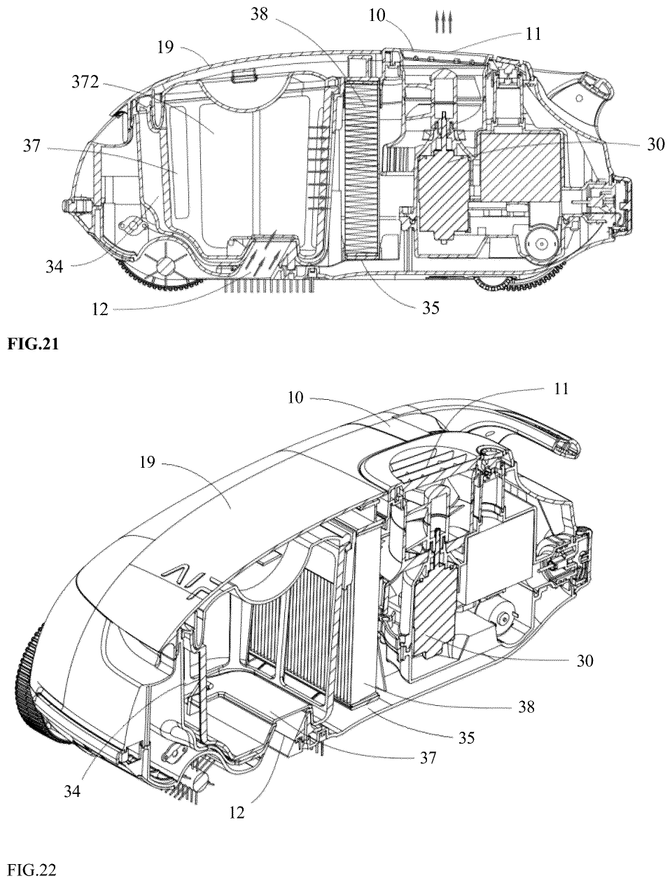

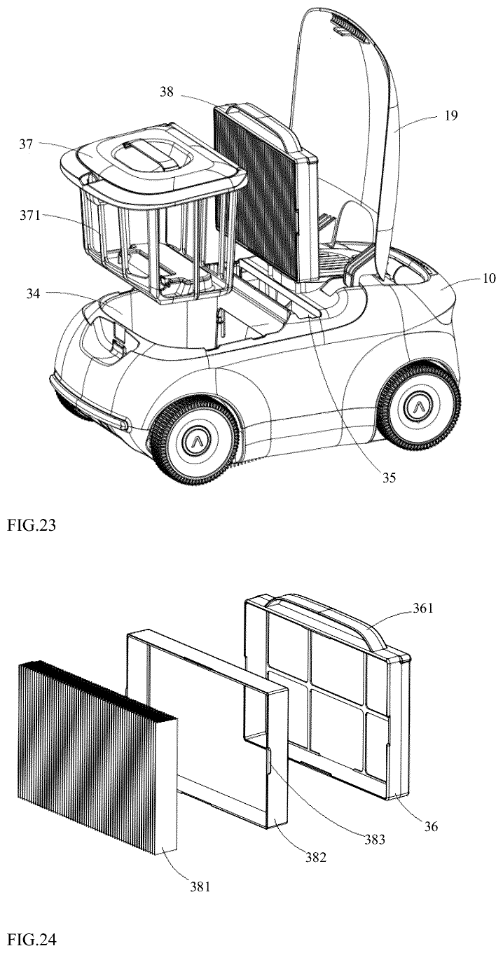

Please refer to FIG. 21 to FIG. 24, in some embodiments, the housing 10 is included. The housing 10 has a water inlet 12 and a water outlet 11. A water flow passage is formed inside the housing 10 between the water inlet 12 and the water outlet 11, and a water pump module 30 is arranged in the water flow passage. The water flow passage is respectively provided with a first mounting groove 34 and a second mounting groove 35 for installing an external filter device, and the number of the second mounting groove 35 is at least one; The first mounting groove 34 is arranged at the upstream of the water flow passage, and the second mounting groove 35 is arranged at the downstream of the water flow passage.

Please refer to FIG. 21 to FIG. 24, an automatic pool cleaner includes a housing 10. The housing 10 has a water inlet 12 and a water outlet 11, and a water flow passage is formed inside the housing 10 between the water inlet 12 and the water outlet 11. The water flow passage is provided with a drainage device 39. The water flow passage is respectively provided with a first mounting groove 34 and a second mounting groove 35 for installing an external filter device, and the number of the second mounting groove 35 is at least one; The first mounting groove 34 is arranged at the upstream of the water flow passage, and the second mounting groove 35 is arranged at the downstream of the water flow passage.

It can be seen from the above description that the beneficial effects of the invention are: The automatic pool cleaner of the present invention is respectively arranged upstream and downstream of the water flow passage with the first mounting groove 34 and at least one of the second mounting grooves 35 to install the external filter device, so that the filter devices of different configurations and combinations can be installed according to the actual situation of the pool that needs to be cleaned, and the pool can be cleaned in a targeted manner to achieve different cleaning effect, which is conducive to improve cleaning efficiency and ensure cleaning quality.

Please refer to FIG. 21 to FIG. 24, an automatic pool cleaner includes a housing 10. The housing 10 has a water inlet 12 and a water outlet 11. A water flow passage is formed inside the housing 10 between the water inlet 12 and the water outlet 11, and a drainage device 39 is arranged in the water flow passage. The water flow passage is respectively provided with a first mounting groove 34 and a second mounting groove 35 for installing an external filter device, and the number of the second mounting groove 35 is at least one; The first mounting groove 34 is arranged at the upstream of the water flow passage, and the second mounting groove 35 is arranged at the downstream of the water flow passage. Specifically, two rollers are arranged on both sides of the housing 10, and a drive motor is also provided in the housing 10 for driving the roller. The water inlet 12 is arranged on the bottom wall of the housing 10, and the water outlet 11 is arranged on the top wall of the housing 10. The drainage device 39 preferably drives the connected motor and impeller. In the embodiment, the number of the second mounting groove 35 is one. In other embodiments, the number of the installed second mounting groove 35 maybe two, three or more.

As shown in FIG. 21 and FIG. 22, in the embodiment, the drainage device 39 is arranged at the water outlet 11, and the second mounting groove 35 is arranged between the drainage device 39 and the first mounting groove 34. It is easy to understand that by arranging the second mounting groove 35 between the drainage device 39 and the first mounting groove 34, the water can be fully filtered before being discharged from the housing 10 by the drainage device 39. In other embodiments, the second mounting groove 35 may be arranged at the water outlet 11, and the drainage device 39 may be arranged between the first mounting groove 34 and the second mounting groove 35. It is easy to understand that the water may be agitated by the drainage device 39 before passing through the second mounting groove 35, so that the fine dust is evenly distributed in the second mounting groove 35 to avoid the concentration of fine dust in the middle of the external filter device, thereby extending the durability of the external filter device in the second mounting groove 35.

In some embodiments, as shown in FIG. 21 to FIG. 23, the automatic pool cleaner also includes at least one second cover 19. The second cover 19 is movably arranged on the housing 10 to open and close the first mounting slot 34 and the second mounting slot 35. Specifically, the first mounting slot 34 and the second mounting slot 35 are communicated with the top wall of the housing 10, and one side of the second cover 19 is connected with the top wall of the housing 10 by rotating. By rotating the second cover 19, the second cover 19 is close to the top wall of the housing 10, so that the second cover 19 can simultaneously close the opening at the top of the first mounting groove 34 and the second mounting groove 35. In other embodiments, the second cover 19 and the housing 10 may be provided with a sliding groove and a clamping strip respectively to achieve a sliding fit, or the second cover 19 and the housing 10 may be provided with a clamping block and a clamping slot respectively to achieve a clamping buckle.

In some embodiments, as shown in FIG. 21 to FIG. 23, the automatic pool cleaner also includes a first filter device 37. The first filter device 37 is detachably installed in the first mounting groove 34. The first filter device 37 includes a first frame 371 and a filter screen. The filter screen is arranged on the first frame 371, and a filter chamber 372 is formed by the filter screen and the first frame 371. A check valve is arranged under the first frame 371 and is communicated with the filter chamber 372. When the first filter device 37 is installed in the first mounting groove 34, the check valve is communicated with the water inlet 12. Specifically, the first frame 371 is a basket type, and the first frame 371 is provided with multiple windows on the wall. The filter screen covers the window on the wall of the first frame 371, so that the first filter device 37 has a large discharge area and is not easy to plug. The filter screen aperture may be set to 180 μm, 250 μm, 380 μm and other apertures, so that the user can choose according to the pollution degree in the pool. The first filter device 37 is installed in the first mounting groove 34 in a removable quick-release mode for easy replacement and cleaning.

As shown in FIG. 21 to FIG. 23, the automatic pool cleaner also includes a second filter device 38 and at least one quick-release mount 36. Optionally, the quick-release mount 36 is removably arranged in the first mounting groove 34 or the second mounting groove 35, or the quick-release mount 36 is removably arranged in the first mounting groove 34 or the second mounting groove 35. A second filter device 38 is detachably arranged on the quick-release mount 36. In the embodiment, the quick-release mount 36 corresponds to the number of the second mounting groove 35 one by one. The quick-dismounting mount 36 is installed in the second mounting groove 35 in a removable quick-release mode, and the second filter device 38 can be quickly disassembled in the second mounting groove 35 through the quick-release mount 36. It is easy to understand that the first filter device 37, the second filter device 38, the drainage device 39, and other devices form a fluid cleaning system.

In some embodiments, as shown in FIG. 24, the second filter device 38 includes a filter screen 381 and a filter screen fixing frame 382. The filter screen 381 is fixed on the filter screen fixing frame 382, and the filter screen fixing frame 382 is detachably installed on the quick-release mount 36. Specifically, the material of the filter screen 51 is preferably nylon and hypalon. The filter screen 381 is rectangular, and the whole body is rectangular after multiple folds; The filter screen fixing frame 382 is a rectangular frame, and the filter screen fixing frame 382 is arranged around the filter screen 381 to keep the filter screen 381 in a certain shape without deformation, so as to facilitate disassembly. The quick-release mount 36 includes a main body and a support bar. The main body is rectangular, and the two ends of multiple support bars are respectively connected with the opposite two side walls of the main body. The filter screen fixing frame 382 is placed in the main body of the quick-release mount 36. As an embodiment, the main body of the quick-release mount 36 is also provided with a handle 361 for the user to withdraw.

In some embodiments, as shown in FIG. 24, the filter screen side frame is provided with a positioning structure or detachable connection structure. The filter screen fixing frame 382 is detachable on the quick-release mount 36 with the positioning structure 383 or the detachable connection structure. Specifically, the positioning structure 383 may be configured as a positioning protrusion or positioning groove; The detachable connection structure may be provided as a clip protrusion or groove, or the detachable connection structure may be provided as a groove or slider to achieve a sliding fit.

In some embodiments, the mesh of the second filter device 38 is smaller than that of the first filter device 37, and the mesh diameter of the filter screen 381 in the second filter device 38 is less than or equal to 2 μm. Considering that the filter screen aperture of the second filter device 38 is small and easy to block, when two filter devices are designed to work at the same time. The width of the second filter device 38 is less than that of the second mounting groove 35. When the second filter device 38 is placed in the second mounting groove 35, the second filter device 38 cannot completely block part of the water flow passage from the first mounting groove 34 to the water outlet 11, so part of the water filtered by the first filter device 37 flows outside the second filter device 38. The second filter 38 has a different width size so that the flow of water outside the second filter device 38 can be adjusted according to the blockage of the second filter 38. The water flowing through the outside of the second filter device 38 accounts for 10-90% of the total flow.

It is understood that in an embodiment, the first mounting groove is arranged roughly parallel to the second mounting groove. The second filter device is not in contact with the first filter device.

It is easy to understand that the first filter device 37 and the second filter device 38 can be used jointly or independently, and the first filter device 37 and the second filter device 38 can be combined in not less than three modes. Mode 1: Simultaneously install the first filter device 37 and the second filter device 38 to use the first filter device 37 to filter the coarse particulate matter in the pool water, and then use the second filter device 38 to filter the fine particulate matter in the pool water. Mode 2: Only install the first filter device 37 without installing the second filter device 38, so that only the coarse particulate matter in the pool water is filtered for the automatic pool cleaner. Mode 2: Only install the second filter device 38 without installing the first filter device 37 to filter the fine particulate matter in the pool water. Combined waterproofing should be determined according to the degree of pollution in the pool.

The working principle of embodiment 1 in the technical solution is summarized as follows: After the automatic pool cleaner is turned on, the drainage device 39 starts to work so that the water flow passage in the housing 10 generates negative pressure, and the check valve at the water inlet 12 opens; The unclean water in the pool is sucked into the first cleaning device through the water inlet 12 for the first filtration to filter out the larger particles in the water, After passing through the first filter device 37, the pool water enters the second filter device 38 to filter out the particulate matter in the water, Finally, it flows out of the housing 10 through the drainage port to achieve the purpose of deep cleaning.

What is claimed is:

1. An automatic pool cleaner comprising:
a housing defining a water inlet and a water outlet;
a filtering module configured to filter fluid from the water inlet to provide filtered fluid;
a detection module;
wherein the detection module comprises a floating unit and a sensing unit; the floating unit is moveable between a first and a second position;
wherein a first signal is outputted from the sensing unit in case of the floating unit in the first position; a second signal is outputted from the sensing unit in case of the floating unit in the second position.

2. The automatic pool cleaner according to claim 1, wherein the floating unit comprises a buoyancy block and a slide rod, the buoyancy block is positioned on the slide rod and configured to slide on the slide rod according to buoyancy force.

3. The automatic pool cleaner according to claim 2, wherein the sensing unit is a position sensor, the position sensor is configured to detect the positions of the buoyancy block on the slide rod and output the first or the second signal respectively.

4. The automatic pool cleaner according to claim 3, wherein the position sensor is arranged on a motion path of the buoyancy block.

5. The automatic pool cleaner according to claim 1, wherein the floating unit is a buoyancy block, and the sensing unit is an angle sensor; the buoyancy block is rotationally connected to the housing, the buoyancy block is swung between the first and second positions based on a buoyancy force imposed on the buoyancy block, and the angle sensor is configured to detect the swing angle of the buoyancy block and output the first or the second signal respectively.

6. The automatic pool cleaner according to claim 1, wherein the floating unit is a buoyancy block, and the sensing unit is a Hall sensor.

7. The automatic pool cleaner according to claim 6, wherein the detection module also comprises a magnetic element, wherein one of the Hall sensor and the magnetic element is positioned on the buoyancy block, and the other is fastened to the housing.

8. The automatic pool cleaner according to claim 1, wherein the sensing unit is an optical position sensor and configured to output the first or the second signal respectively according to whether a light path of the optical position sensor is blocked by the floating unit.

9. The automatic pool cleaner according to claim 1, wherein the floating unit is located on front part of the automatic pool cleaner.

10. The automatic pool cleaner according to claim 1, wherein the floating unit is located on top part of the automatic pool cleaner.

11. An automatic pool cleaner, comprising:
a housing;
a floating unit that is moveable relative to the housing according to buoyancy; and
a sensing unit configured to generate a signal responsive to a position of the floating unit to determine whether the automatic pool cleaner is out of waterline.

12. The automatic pool cleaner according to claim 11, wherein the floating unit comprises a buoyancy block and a slide rod, the buoyancy block is positioned on the slide rod and configured to slide on the slide rod according to buoyancy force.

13. The automatic pool cleaner according to claim 12, wherein the sensing unit is a position sensor, the position sensor is configured to detect the positions of the buoyancy block on the slide rod and generate a corresponding signal.

14. The automatic pool cleaner according to claim 13, wherein the position sensor is arranged on a motion path of the buoyancy block.

15. The automatic pool cleaner according to claim 11, wherein the floating unit is a buoyancy block, and the sensing unit is an angle sensor; the buoyancy block is rotationally connected to the housing, the buoyancy block is swung according to a buoyancy force imposed on the buoyancy block, and the angle sensor is configured to detect the swing angle of the buoyancy block and generate a corresponding signal.

16. The automatic pool cleaner according to claim 11, wherein the floating unit is a buoyancy block, and the sensing unit is a Hall sensor.

17. The automatic pool cleaner according to claim 16, wherein the sensing unit comprises a magnetic element, wherein one of the Hall sensor and the magnetic element is positioned on the buoyancy block, and the other is fastened to the housing.

18. The automatic pool cleaner according to claim 11, wherein the sensing unit is an optical position sensor and configured to generate a corresponding signal according to whether a light path of the optical position sensor is blocked by the floating unit.

19. The automatic pool cleaner according to claim 11, further comprising a water pump module, wherein the water pump module is configured to vary a characteristic of operation according to the signal generated by the sensing unit.

20. The automatic pool cleaner according to claim 11, further comprising a drive module, wherein the drive module is configured to vary a characteristic of operation according to the signal generated by the sensing unit.
